(19) United States
(12) Patent Application Publication
(10) Pub. No.: US 2024/0186513 A1
(43) Pub. Date: Jun. 6, 2024

(54) IMPROVED ELECTRODES FOR ENERGY STORAGE DEVICES

(71) Applicant: LI-S ENERGY LIMITED, Queensland (AU)

(72) Inventors: Ian Ying Chen, Victoria (AU); Baozhi Yu, Victoria (AU); Ye Fan, Victoria (AU)

(21) Appl. No.: 18/550,771

(22) PCT Filed: Mar. 17, 2022
(86) PCT No.: PCT/AU2022/050237

§ 371 Date: Sep. 15, 2023

(30) Foreign Application Priority Data
Mar. 17, 2021 (AU) 2021900777
May 7, 2021 (AU) 2021901368

(51) Int. Cl. H01M 4/583; H01M 4/02; H01M 4/36; H01M 4/62

(52) U.S. Cl. CPC H01M 4/583; H01M 4/366; H01M 4/623; H01M 4/625; H01M 2004/021; H01M 2004/028

(57) ABSTRACT

Electrodes having associated therewith a protective porous film or coating of boron nitride nanotubes (BNNTs).

### FIELD OF THE INVENTION

The invention relates to a protective BNNT based porous network or mesh for an electrode for use in energy storage devices, and in particular improved S-cathodes and/or improved metal electrodes including Li, Na, K, Al, Zn anodes for metal=sulfur batteries, particularly Li anodes for lithium-sulfur batteries.

### BACKGROUND

The development of energy-storage systems with high energy density, long cycle life, high efficiency, and low cost is critical for transportation, grid storage, electric vehicles, and advanced portable electronics applications. Lithium-metal based batteries, including lithium-sulfur (Li—S) batteries and Li-air batteries, can deliver a specific energy of ˜650 and ˜950 Wh kg⁻¹ respectively, which is 2-3 times higher than that of the current Li ion batteries, and thus are considered next-generation batteries. Indeed, among the current battery systems, Li—S batteries are attractive candidates for serving as next generation batteries of theoretical high energy density. In such batteries, the Li-metal anode is the indispensable component because of its high theoretical specific capacity of 3860 mAh g⁻¹ and the lowest redox potential (−3.04 V vs the standard hydrogen potential electrode). In particular, lithium-sulfur (Li—S) technology is based on the multistep electrochemical reaction of 16Li+S₈→8Li₂S. However, the dissolution of intermediate lithium-sulfur polysulfide products formed during the charge/discharge process, the so-called shuttle effect, causes severe capacity decay and lower coulombic efficiency of the batteries as insulating and insoluble precipitates (e.g., Li₂S₂/Li₂S) accumulate on the surface of the cathode, anode and separator during cycling leading to continuous increase in battery impedance. This means that active material is poorly recycled and discharge capacity as well as Coulombic efficiency fade quickly. Another issue relates to the formation of dendrites on the lithium metal anode which severely limit cycling capability and can cause safely concerns. Similar issues exist for other metal anodes including sodium metal electrodes, aluminium metal electrodes, zinc metal electrodes and so on. The dendrite problem is particularly an issue at higher current densities. Such problems mean, despite their promise, lithium-sulfur batteries have yet to be mass produced. Historically, the challenge in developing lithium-sulfur batteries has been effectively optimising and stabilising the battery components during charge and discharge cycling. Typical lithium-sulfur batteries tended to fail after a low number of recharge cycles, making them of little use for most commercial applications.

A variety of strategies have been tried to solve the polysulfide (PS) issue, including fabrication of carbon-sulfur composites, surface modification of conducting polymers, and the modification of electrolyte. Though these approaches lead to improved electrical conductivity, cyclability, and capacity, there are still some challenging issues such as polysulfide (PS) leaking into electrolyte, fast capacity decay in subsequent cycles, and a low lithium-ion conductivity in new electrolytes and their stability. More recently, introducing an interlayer between the sulfur cathode and separator, such as a carbon paper, carbonized eggshell membrane, carbon nanotube paper, and an acetylene black mesh, has been developed for the absorption of soluble PS and reuse of the absorbed active material. This strategy significantly enhances both rate performance and cycling life of batteries. However, the complexity of the interlayer preparation, weak interaction between the interlayer and polar polysulfide (PS) anions, and the unacceptable thickness and heavy mass of the interlayer affect the Li—S cell performance significantly.

There is therefore an ongoing need for further improvement of the performance of S cathode electrodes, which at least partially addresses one or more of the above-mentioned short-comings or provides a useful alternative. In particular, developing a new lightweight solution that can alleviate polysulfide (PS) transport from the sulfur cathode to the anode would be welcomed.

Turning to the dendrite problem. Metal anodes, including Li anodes, have two issues: (1) the virtually infinite relative volume change of the hostless anode which occurs during metal stripping and plating results in mechanical instability and recurrent cracking and healing of the passivating solid-electrolyte-interface (SEI) layer with associated capacity loss over time and reduced cycle life; (2) uncontrollable formation of metal dendrites during charge/discharge cycles leading to internal short circuits, low Coulombic efficiency, poor cyclic stability, and serious safety problems. Indeed, the cracks occurring during continuous cycles of SEI cracking/healing enhance metal-ion flux to the metal surface which results in non-uniform metal deposition and dendrite formation.

Various attempts to regulate undesired dendritic formation include new electrolytes and electrolyte additives, use of solid electrolytes, addition of artificial physical protective layers, and design of dendrite-free current collectors. Although these strategies can effectively suppress the formation and growth of metal dendrites, most of them fail to overcome the issue of infinite volume change. Maintaining or supplementing the quality and integrity of the SEI layer is critical for the efficient and stable operation of metal anodes. Ideal SEI layers will be (i) homogeneous in terms of composition and morphology, to prevent only limited locations of metal nucleation and growth; (ii) have a high elastic modulus and compact structure to suppress dendrite formation; and (iii) be flexible enough to accommodate interface fluctuations which occur during battery cycling while avoid repeated breakdown/repair cycles; (iv) have high ionic conductivity to facilitate the uniform distribution and transport of metal-ions across the entire electrode surface. Unfortunately, to date, native SEI layers are lacking in one or more of these requirements (as indicated by poor cycling ability) thus overlining the need for new design of improved artificial SEIs or pseudo SEls or other structures which possess the above desirable characteristics or can impart these characteristics to native SEIs. Layered boron nitride (BN) and boron nitride nanotubes (BNNTs) are polymorphs of boron nitride. BNNTs are structurally similar (isostructural) to carbon nanotubes except that carbon atoms are alternatively substituted by nitrogen and boron atoms, while layered boron nitride (BN) is structurally similar to graphite in which boron and nitrogen atoms are replaced by carbon atoms. BNNTs resemble a rolled graphite-like BN sheet (honeycomb BNs (h-BNs)) comprising N and B atoms instead of C atoms. BNNTs may be single walled or multiwalled. Ionic interactions exist between the neighbouring BN layers as a result of the partial ionic character of the B—N bond. BNNTs are cylindrical in morphology with sub-micron diameters and micrometre lengths.

US 2019/0123324 describes a porous separator for an ion battery which comprises a porous scaffolding such as a BNNT nanoporous scaffolding as a support for a conformal coating of a thermoresponsive polymeric material (polyethylene and in some cases chemical modifying dopants) which acts as a reversible locally thermoresponsive switching mechanism that prevents thermal runaway by sterically hindering ion flow through the separator as the polymer expands on experiencing a threshold temperature to reduces pore size or closes the separator pores to shut down ion flow in the battery, lowering temperature to prevent thermal failure. The modified separator is included in a battery between the anode and cathode. However, the BNNT is not attached to the battery electrodes and there is no disclosure of a BNNT network/deposit which is intimately bound or interfacial contact to one or both of the electrodes. Furthermore, there is no disclosure of the polymer being used binder in particulate form which is dispersed throughout the BNNT network rather a thermoresponsive conformal film of polymer is required.

US 2011/0086965 discloses boron nitride nanosheets (BNNS) containing three layered hexagonal boron nitride (h-BN) which is in a form of multi-layered hexagonal boron nitride with some of its layer peeled, and can be produced by dispersing pristine hBN powder in an organic solvent and by subjecting the fluid dispersion to ultrasonication. US 2011/0086965 does not discuss boron nitride nanotubes (BNNTs) which as explained above are structurally and functionally very different to boron nitride nanosheets BNNS.

### STATEMENTS OF THE INVENTION

In a first aspect, the invention provides a sulfur (S) cathode for an energy storage device having a film of a composite of boron nitride nanotubes (BNNTs) and at least one polymeric binder, wherein the film of the composite intimately contacts at least one surface of the electrode as a porous network which is selectively permeable to transport metal ions and electrolyte used in the energy storage device but is impermeable to polysulfides. Desirably, the film of the composite BNNT porous network is directly attached to the S cathode such that there is substantial interfacial contact between the entire film of composite and the entire S cathode surface. Desirably there are no micro gaps or micro spaces (0.5 micron or higher level) between the film and the S cathode surface.

In a second aspect, the invention provides a sulfur (S) based cathode comprising a sulfur-cathode material having associated therewith a porous film of boron nitride nanotubes (BNNTs).

In a third aspect, the invention provides an energy storage device comprising one or more sulfur (S) based electrodes according to the first aspect or second aspect.

In a fourth aspect, the invention provides an electronic device comprising a sulfur (S) based cathode of the first or second aspects, and/or the energy storage device of the third aspect.

In a fifth aspect, the invention provides a use of the electronic device of the fourth aspect, in transportation, grid storage, electric vehicles, or portable electronics applications.

In a sixth aspect, the invention provides a use of one or more BNNT layers as a polysulfide diffusion blocking film or a reversible trap for polysulfide in a sulfur (S) based cathode of an energy storage device.

In a seventh aspect, the invention provides a metal-sulfur energy storage device comprising
at least one sulfur (S) based electrode having a film of a composite of boron nitride nanotubes (BNNTs) and at least one polymeric binder, wherein the film of the composite intimately contacts at least one surface of the electrode as a BNNT porous network which is selectively permeable to transport metal ions and electrolyte used in the energy storage device but is impermeable to polysulfides;
at least one metal electrode having a coating of a composite of boron nitride nanotubes (BNNTs) and at least one polymeric binder, wherein the coating of the composite intimately contacts at least one surface of the metal electrode as a porous mesh which is selectively permeable to transport metal ions used in the energy storage device wherein the composite is physically and/or chemically bonded to the surface of the electrode.

In an eight aspect, the invention provides a lithium-sulfur energy storage device comprising
at least one sulfur (S) based electrode having a composite of boron nitride nanotubes (BNNTs) and at least one polymeric binder, wherein a film of the composite intimately contacts at least one surface of the electrode as a porous network which is selectively permeable to transport metal ions and electrolyte used in the energy storage device but is impermeable to polysulfides;
at least one lithium metal electrode having a composite of boron nitride nanotubes (BNNTs) and at least one polymeric binder, wherein a coating of the composite intimately contacts at least one surface of the electrode as a porous mesh which is selectively permeable to lithium ions wherein the composite is physically and/or chemically bonded to the surface of the electrode.

Desirably, the coating of the composite BNNT porous mesh is configured to reversibly trap polysulfides which means on cycling trapped sulfur (in the form of polysufides) remains active in that the polysulfide returns/escapes from the porous network and is able to contact the S cathode mass to participate in a redox reaction where elemental S is formed at the cathode. Films of BNNT porous network that result in permanently trapped PS are not desired as this results in inactive cathode material leading to capacity fade as cycling continues.

### DESCRIPTION OF THE DRAWINGS

Embodiments of the invention will herein be illustrated by way of example only with reference to the accompanying drawings in which:

FIG. 1 illustrates optical image of S/graphene electrodes (cathodes) (a) without and (b) with a film of BNNT porous network which comprise polymeric binder. The BNNT porous mesh results in a grey colour in the image; (c) SEM images of porous surface of a typical sulfur/graphene cathode and (d) cross-section SEM image showing the BNNT network component, the electrode material component and the aluminium current collector component, and (e, f) top-view SEM images of BNNT network on the “protected” S/graphene cathode. The particulate nature of the binder between BNNT strands or fibres is evident on high magnification in (f) in the form of spheroidal particles. Areas of the pores/gaps in the electrode material surfaces visible in (c) are filled to some degree with the composite BNNT/polymer material due to the slurry casting manufacture process described herein and results in excellent intimate contact between the composite and the electrode material;

FIG. 2 illustrates cycling stability in terms of % capacity retention v cycle number of Li—S coin cells with different thickness of BNNT network on the S cathode, e.g., based on application of (a) 5% by weight BNNT in the slurry or (b) a 10% by weight BNNT in the slurry to the cathode followed by evaporation of solvent. The thickness of the film in microns as determined by SEM analysis is shown to the right of each curve as is the % capacity retention in parenthesis. The results are compared to an equivalent cell without BNNT on the S cathode (see curve labelled “without BNNT”) clearly showing the benefit of the BNNT film on the capacity retention over prolonged cycling, where after 500 cycles, as high as 90% capacity retention was possible for the composite film formed from a 5 wt % slurry used to form a 2.3-micron BNNT film compared to only 35% capacity retention for the electrode without the protective BNNTs porous network.

FIG. 3 illustrates (a) SEM images and (b) TEM images of the BNNT starting material (no binder present) giving an indication of the typical length and diameter of some of the BNNTs used;

FIG. 4 illustrates (a) a comparison of an electrolyte solution colour of polysulfide solution (intense bright yellow) and change in colour (instantaneous loss of bright yellow colour) when BNNTs are added demonstrating that polysulfide is adsorbed onto or otherwise trapped/retained on the BNNTs. Note the electrolyte used is the one described in the experimental section); (b) shows the IR spectra for three polysulfide/electrolyte solutions with 0 mg, 8 mg and 15 mg BNNTs added where the PS8 absorption peak reduces in intensity with increasing concentration of BNNTs indicating that PS in solution is adsorbed onto or otherwise associated/retained on the BNNTs; (c) show the Raman spectral analysis of BNNTs recovered from the polysulfide/electrolyte solution experiment where bands for B—S bonds and N—S bonds are indicated, demonstrating adsorption of sulfur from the polysulfide to the boron and nitrogen atoms of the BNNT;

FIG. 5 illustrates (a) (left panel) SEM analysis of a film of composite of BNNT/LA133 polymeric binder whereby the porous BNNT network is formed from an aqueous solvent system and (b) (right panel) SEM analysis of a composite of BNNT/PVDF polymeric binder whereby the porous network of the composite is formed from an organic solvent system. Comparison of the images shows that in each case the structure, porosity and/or morphology of the film's porous network is essentially the same, strongly suggesting equivalent performance in terms of polysulfide adsorption/blocking/capture despite use of a different binder;

FIG. 6 illustrates the effect of ratio of high porosity graphene:high surface area graphene in the BNNTs network protected S cathode on specific capacity (mAh/g). As can be seen from the figure, good specific capacity of around 1000 mAh/g is achieved at ratios of 2:8, 4:6, 5:5 and 8:2. However, unexpectedly the ratio of 6:4 gives a specific capacity of close to 1400 mAh/g;

FIG. 7 illustrates (a) the specific capacity of a test S-cathode with a variety of BNNTs loading densities with BNNTs improving the specific capacity in all cases compared to no BNNTs. A BNNTs loading density of about 0.1 to about 0.25 mg/cm² gives good specific capacity values even at 100 cycles; while (b) shows the % capacity retention (relative to capacity of 1st cycle) as a function of BNNTs loading density in mg/cm². A BNNTs loading density of about 0.1 to about 0.25 mg/cm² gives a particularly good performance in terms of % capacity retention c.f. the 1st cycle. About means±2%.

FIG. 8 illustrates (a) the cross-section and (b) top-view SEM images of a coating of BNNT porous mesh formed directly on a lithium film from a BNNT/polymer composite slurry using different doctor blade height Note, the thickness control and optimisation of the BNNT porous mesh can be more easily and more clearly observed on Cu foil than on lithium film, and thus Cu foil can be used as a model of a metal surface for optimised mesh layer thickness development. Since the film is formed in-situ on the metal surface from the slurry technique, it will be understood that the composite BNNT porous mesh when formed has excellent interfacial contact between the BNNTs and the metal electrode surface which is substantially flat or planar as the BNNT/polymer slurry sits on top of the electrode on formation. As the solvent is evaporated off to form the film, the BNNT/polymer compacts down well onto the metal electrode surface. This means that there are very few/very small gaps or spaces between the porous network (typically any gaps/spaces present between the network and the metal surface are at the nanoscale) which are much smaller than gaps/spaces that would be present from a preformed composite BNNT/polymer porous network being placed on top of the metal electrode surface. The slurry formation method therefore is useful to produce the excellent interfacial contact observed in the present invention. When the metal electrode is cycled, the SEI is formed (a few nm thick) between the metal surface and the intimately contacting BNNT porous network. This SEI forms because of the reaction between the electrolyte and the metal anodes. This SEI is a passivation layer which can protect the metal and provide a path for metal ions to the metal electrode. The inventors believe that the BNNT mesh reinforces the SEI and also realize a uniform deposition of the metal ions which cross the mesh and the SEI. To ensure continuity in the attachment through the ultrathin SEI it is important that the BNNT porous network has as good an interfacial contact as possible with the metal electrode surface. Before and after the SEI formation, it is believed that the BNNT porous network is one or more of physically and/or chemically bonded to the metal electrode surface and that attachment is likely strengthened by the SEI when it is formed;

FIG. 9 illustrates the voltage profiles of Li ion plating and stripping cycling performance of the symmetric Li coin cells where the lithium foils used in the symmetric cells are coated with different mass loading of BNNT to form a range of coatings of composite BNNT porous meshes: (a) 0.1 mg/cm², (b) 0.2 mg/cm², (c) 0.3 mg/cm², (d) 0.4 mg/cm², (e) 0.5 mg/cm², (f) 1 mg/cm², (g) 1.5 mg/cm², and (h) 2 mg/cm²;

FIG. 10 illustrates EIS analysis of the Li symmetric coin cells with different BNNT mass loading on the Li chips to form a range of coatings of composite BNNT porous meshes: (a) 0.1 mg/cm², (b) 0.2 mg/cm², (c) 0.3 mg/cm², (d) 0.4 mg/cm², (e) 0.5 mg/cm², (f) 1 mg/cm², (g) 1.5 mg/cm², and (h) 2 mg/cm²;

FIG. 11 illustrates the Arrhenius plot made according to the Nyquist plots of the Li symmetric coin cells with different BNNT mass loading in the porous mesh on the Li chips;

FIG. 12 illustrates long-term cycling performance of a symmetric pouch cell with fresh lithium film electrode (a) without and (b) with the coating of the composite BNNT porous mesh. Without the BNNT porous mesh the overpotential increases with cycling as dendrite formation occurs on lithium metal with cell failure occurring after only 45 cycles, whereas the cell with the coating of BNNT porous mesh on the lithium metal cycles with a steady overpotential for at least 1000 cycles demonstrating lack of dendrite growth as a result of the protective BNNT mesh on the lithium;

FIG. 13 illustrates the voltage profiles of plating and stripping cycling performance of symmetric Al batteries and symmetric Zn batteries with different metal electrodes. (a) Bare Al (b) Al with coating of the composite BNNT porous mesh; (c) Bare Zn (d) Zn with coating of the composite BNNT porous mesh. The BNNT loading of the mesh in each case is 0.4 mg/cm²;

FIG. 14 illustrates a proposed mechanism of a coating of BNNT porous mesh preventing the dendrite growth by converting non-uniform lithium-ion flow (localised) reaching the lithium metal anode in a localised fashion to a more distributed lithium ion flow through the mesh to the anode such that the transport metal ions reaching the entire lithium surface are more homogeneously distributed (delocalised) across the entire surface of the metal electrode. Advantages of this arrangement are discussed below;

FIG. 15 illustrates an exploded view structure of a Li—S battery with coating of BNNT porous mesh for lithium anode protection and a film of BNNT porous network for S cathode protection wherein reversibly trapped PS is observed within the film of BNNT porous network;

FIG. 16 illustrates capacity and specific capacity of two pouch cells (one with BNNT on cathode and one without) involving 20 cm² pouch cells with an active cathode mass loading of 30.4 mAh/g. The bottom line represents the cell without BNNT and it failed after just over 100 cycles so the results do not extend beyond the dotted line. The data show that deposition of the film of BNNT porous network was beneficial to the performance of the cathode, leading to higher utilisation of the sulfur active material and no deleterious effects such as capacitive charge/self-discharge processes were evident. The reversible cycled capacity of the Li—S cell was improved by 15% after 100 cycles upon addition of the BNNT to the cathode. A capacity of 18.9 mAh (622 mAh/g_{sulfur}) was achieved after 100 cycles, and 16.7 mAh (550 mAh/g_{sulfur}) after 600 cycles demonstrating a high level of stability. The capacity retention of the cell without BNNT drops to lower than the 60% threshold after 27 cycles (17.5 mAh, 574 mAh/g_{sulfur}), while that of the cell with BNNT has since continued to cycle for more than 1200 cycles without falling below the 60% capacity threshold. Based on the testing procedure developed and presented, the improvement in retained capacity is attributed to the presence of the BNNT porous network on the cathode; and

FIG. 17 illustrates (a) the capacity retention and (b) the coulombic efficiency of Li—S coin cells without BNNTs protection, and with BNNT protection on both cathode and anode, respectively. The BNNT loading of the layer and the mesh is 0.2 mg/cm² and 0.4 mg/cm², respectively. All tested cells are tested at a rate of 0.2 at 25° C. The initial specific capacity of the bare Li—S cell and the cell with BNNT protection on both sides are 1158 and 1251.6 mAh/g, respectively. It can be found that the Li—S cell without any protection keeps a capacity retention of 74.26% and a coulombic efficiency of 83% after 60 cycles, while the cell with BNNT protection keeps demonstrates a higher capacity retention of 95.55% and a higher coulombic efficiency of 96.8% for the same amount of cycling. Studies are continuing but the benefit of the composite BNNT porous protecting layers on the electrodes are clear.

### DETAILED DESCRIPTION OF THE INVENTION

The present invention relates to films and/or coatings of a boron nitride nanotubes (BNNTs) porous network or porous mesh for electrodes used in an energy storage device. The BNNT is preferably in the form of a composite BNNT material comprising BNNTs and a polymeric binder. The porous network or porous mesh is selectively permeable to transport metal ions used in the energy storage device. It will be understood that the electrode is one which can be used in an energy storage device such a battery particularly a secondary battery which is rechargeable. The electrode may be a sulfur electrode or a metal electrode such as an alkali metal, particularly sodium or lithium, or aluminium, magnesium or zinc.

Desirably, the BNNTs of the composite are substantially free, preferably completely free, of impurities such as hexagonal boron nitride (hBN) and/or elemental boron (B). The BNNT used herein have only very small amounts of impurities such as metal catalysts, hexagonal boron nitride, and/or elemental boron. Preferred BNNTs are at least 95%, at least 96%, at least 97%, at least 98% or in some cases at least 99% pure.

Preferably, the composite BNNT porous network or porous mesh is electronically insulating, but permeable to metal transports ions (e.g., metal ions of the metallic based anode material) which are used in a particular energy storage device of interest. The porosity/porous structure of the BNNT porous network, mesh or deposit can be observed using SEM and tested with a BET analysis method if desired.

Suitably, the binder is present in the composite as solid spheroidal shaped binder particles which can also be observed in the SEM images provided herein. Desirably at least a portion of the polymer binder is present in the composite as solid particulates which fix or adhere strands of BNNTs in the composite together to form the porous network (in case of S cathode) or porous mesh (in case of a metal anode). A substantial part of the binder present is in solid particulate form rather than in the form of a distinct conformal coating of polymer on all the BNNT strands etc. Suitably, strands of BNNTs in the composite are not completely conformally coated with the polymeric binder. A conformal coating of polymer around all of the BNNTs is not desirable due to the possibility excess thermal expansion of the polymer which may negatively affect the optimised pore size of the BNNT network/mesh. The incorrect pore size can negatively affect one or more of the kinetics, device internal resistance, capacity and capacity retention on cycling.

Desirably, the film of composite is physically and/or chemically bonded to the surface of the electrode. This is the case for the S cathode or the metal anodes as described herein later in more detail.

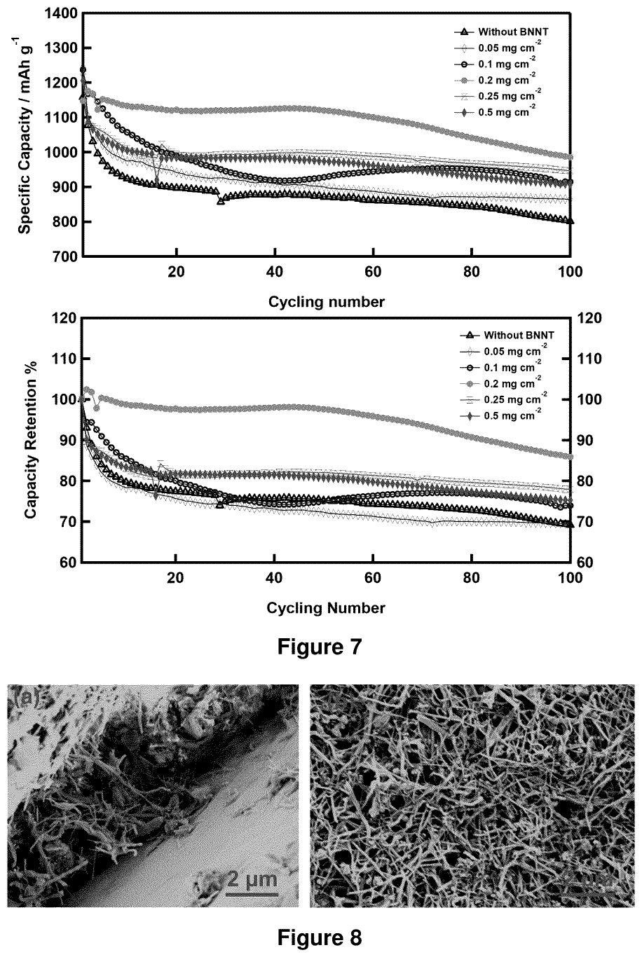

The film of BNNT porous network when optimised appropriately is particularly useful for blocking polysulfide shuttling from a S cathode material. Preferred films have an optimised BNNT loading, density and thickness which synergistically prevents polysulfide diffusion through the film of BNNT porous network by reversibly trapping polysulfide within the porous network while retaining its activity meaning the active can still escape the composite network and revert back to the cathode mass. The temporarily trapped polysulfide must be released from the porous network on the reverse cycle as active S which is able to contact the S cathode material mass. The optimised networks described herein are preferred as they are configured to efficiency and reversibly trap S but without resulting in inactive S in the form of PS permanently trapped in the BNNT porous network. The functionality of the optimised film of BNNT porous networks described herein is demonstrated by retention of very good specific capacity (% capacity retention) even after many cycles due to reversible polysulfide trapping in film of BNNT porous network associated with the S-cathode (see e.g., FIG. 7).

The BNNTs in the form of a coating of a BNNT porous mesh are also particularly useful for SEI reinforcement and/or for preventing dendrite formation on metal electrodes which suffer from dendrite formation such as lithium metal. Preferred coatings of the composite BNNT/polymer mesh in this embodiment are optimised in terms of BNNT loading, density and thickness which synergistically operate to allow selective passage of transport metal ions through the mesh to the metal electrode surface but in a way that homogenously disperses an approaching flux of ions reaching the mesh right across the surface of the electrode after passing through the mesh. Homogenously distributing the transport metal ions across the electrode surface dramatically reduces metal dendrite formation. The optimised mesh is also of a suitable thickness that reinforces the native SEI that forms on the electrode and protects it from damage resulting from volume expansion that occurs in a hostless electrode material including metals. Reducing SEI damage in this way is also protective against dendrite formation. The functionality of the optimised coating of BNNT porous mesh described herein is demonstrated by demonstration of very stable overpotential even after many cycles due to lack of dendrite formation and maintenance of low and stable internal resistance during metal stripping/plating experiments.

In both cases, the composite BNNTs/binder materials enhance the cycling performance of the electrode when used in an energy storage device. A protected electrode material is provided with the film or coating of the BNNT network or mesh of the invention and may be used as cathode and/or anode in an energy storage device. As one example, a film of the BNNT network is used to protect the sulfur cathode and/or a coating of BNNT mesh is used to protect the metal anode in a metal-sulfur energy storage device, for example a lithium electrode in a lithium sulfur energy storage device. The difference between a film and a coating lie in the thickness of the composite on the electrode and/or density of the BNNT used. There are advantages for a S cathode and a metal anode for different reasons as described herein and either type of protected electrode can be used in a device. Preferably, a BNNT protected sulfur cathode and a BNNT protected metal anode are both used in an improved device, such as an improved lithium sulfur energy storage device where both electrodes are protected (cathode and anode). The inventors believe that the protected electrodes work synergistically together in a lithium sulfur energy storage device to provide improved cycle life performance for a lithium sulfur battery (see FIG. 17). The effects are translatable to other metal batteries such as Na, K, AL and Zn. The film of BNNT porous network stabilises the cathode and protects it, while the coating of BNNT mesh protects the anode by reducing dendrite formation through reinforcement of the SEI layer and spreading metal ion flux reaching the electrode across the surface of the electrode. The structure of a Li—S battery with BNNT protective layers on each electrode is shown in FIG. 15 below. During operation of a lithium sulfur battery, lithium ions move between the lithium anode to the sulfur cathode. The lithium ions combine with sulfur to create different lithium polysulfide compounds in the cathode. Some of these polysulfides are soluble in the battery electrolyte and can deposit on the anode. This results in permanent loss of active sulfur from the cathode. Over relatively few charge cycles, the active sulfur loss causes the battery capacity to deteriorate. The BNNTs within the battery construction act to allow lithium ions to flow through, while reducing the movement of lithium polysulfides. This assists sulfur retention as active material in the cathode, helping to maintain battery capacity during charge and discharge. Further, the presence of lithium within the sulfur cathode structure causes it to expand dramatically, which can damage the battery's structural integrity causing loss of capacity and failure. The BNNT is thought to assists by providing additional structural support to the cathode. This helps mitigate the effects of cathode expansion and contraction, reducing risk of failure due to mechanical stress. At the lithium anode, during battery cycling, lithium ions return to the lithium metal anode. On arrival they can deposit irregularly, causing lithium dendrites to grow on the anode surface. These can damage the insulating separator, causing short circuits and failure. Inclusion of the protective BNNT network/mesh on the anode is thought to creates a more uniform ion influx across the anode surface, impeding dendrite formation and anode degradation even after many cycles maintaining specific capacity and reducing the risk of battery failure over a much longer cycle life.

Since BNNT conducts heat far more efficiently than copper, it is also thought that the BNNT in the battery construction may assist to more evenly spread generated heat, potentially reducing concentrated hot spots and the associated mechanical and chemical stress at such hot spots. This in turn may help to further increase the speed of safe charging and may reduce the risk of failure. This is an improvement over lithium-ion and conventional lithium sulfur batteries can develop concentrated heat spots during charge and discharge which causes increased mechanical and chemical stress, limiting the speed of safe charging, and increasing the risk of failure due to excessive localised heating.

### Electrodes

Described herein is an electrode for an energy storage device having a composite of boron nitride nanotubes (BNNTs) and at least one polymeric binder, wherein the composite intimately contacts at least one surface of the electrode as a porous network or porous mesh which is selectively permeable to transport metal ions used in the energy storage device, wherein at least a portion of the polymer binder is present as particulates which fix strands of the BNNTs together to form the porous network or porous mesh. Also described herein is a sulfur (S) based electrode for an energy storage device having a composite of boron nitride nanotubes (BNNTs) and at least one polymeric binder, wherein the composite intimately contacts at least one surface of the electrode as a porous network or porous mesh which is selectively permeable to transport metal ions and electrolyte used in the energy storage device but not polysulfides, that is the composite is impermeable to polysulfides. Also described herein is a sulfur (S) based electrode for an energy storage device having a film of a composite of boron nitride nanotubes (BNNTs) and at least one polymeric binder, wherein the film of the composite intimately contacts at least one surface of the electrode as a porous network which is selectively permeable to transport metal ions and electrolyte used in the energy storage device but not polysulfides.

In S cathode embodiments, the film of composite has an average thickness of from about 0.9 microns to about 5 microns, preferably from about 1.5 microns to about 3.5 microns, most preferably about 2.5 microns. Desirably the film of composite has an areal density or BNNT loading of from about 0.05 mg cm⁻² to about 3.5 mg cm⁻², more preferably from about 0.05 to about 1 mg cm⁻², more preferably from about 0.05 to about 0.5 mg cm⁻², most preferably about 0.2 to about 0.25 mg cm⁻², most preferably about 0.2 mg cm⁻². In some embodiments, the S is present at a loading of about 1 mg cm⁻² to about 5 mg cm⁻², preferably at about 3 mg cm⁻². About means±2%.

Described herein is a metal or metal based electrode for an energy storage device having a composite of boron nitride nanotubes (BNNTs) and at least one polymeric binder, wherein the composite intimately contacts at least one surface of the electrode as a porous mesh which is selectively permeable to transport metal ions used in the energy storage device, wherein at least a portion of the polymer binder is present as particulates which fix strands of the BNNTs together to form the porous network or porous mesh. Described herein is a metal electrode for an energy storage device having a composite of boron nitride nanotubes (BNNTs) and at least one polymeric binder, wherein a coating of the composite intimately contacts at least one surface of the electrode as a porous mesh which is selectively permeable to transport metal ions used in the energy storage device, wherein the composite is physically and/or chemically bonded to the surface of the electrode.

Desirably, the composite has an average thickness of from about 1 microns to about 50 microns, more preferably from about 2 microns to about 25 microns, more preferably about 3 to 10 microns, preferably around 1.5 microns or around 7.5 microns, most preferably about 5 microns. In some embodiments, the coating of the composite has an areal density or BNNT loading of from about 0.2 mg cm⁻² to about 8 mg cm⁻², about 0.1 mg cm⁻² to about 2.5 mg cm⁻², more preferably from about 0.1 to about 2 mg cm⁻², most preferably about 0.4 mg cm⁻². These thickness and loadings are particularly desirable for a mesh for a metal electrode.

Described herein is an electrode for an energy storage device having boron nitride nanotubes (BNNTs) provided on at least one surface of the electrode as a porous network or porous mesh which is selectively permeable to transport metal ions used in the energy storage device. Suitably, the network or mesh is a composite of BNNTs and a polymeric binder.

Described herein is an electrode for an energy storage device having a composite of boron nitride nanotubes (BNNTs) and at least one polymeric binder provided on at least one surface of the electrode as a porous network, mesh or deposit which is selectively permeable to transport metal ions used in the energy storage device. Most preferably the binder is present in the BNNT porous network or porous mesh at a concentration of about 15 wt % or less, preferably about 10 wt % or less of the BNNT component (about means±2%). Desirably, a portion of the binder present in particulate form. More desirably, at least 50% of the binder is present in particulate form. The binder particular fix or adhere BNNT strands or fibres together providing stability to the porous network, mesh or deposit. In some embodiments, the BNNT strands or fibres are not completely conformally coated with a layer of the polymeric binder. In some embodiments, less than 75%, 50%, or 25% or less of the BNNT strands or fibres are coated with a conformal layer of the polymeric binder. Compositional details of the polymeric binder are described below. As used herein, for embodiments comprising binder, the term BNNTs signifies a composite BNNTs/polymer binder, that it, binder is present in the porous network or porous mesh.

The BNNTs intimately contact the electrode/electrode material. The BNNTs may be physically and/or chemically bonded or otherwise fused to the electrode material so that any gaps/spaces present between each component is at the nanolevel rather than at the micron level. In some embodiments involving an S cathode, the BNNTs in the film or the coating infiltrate pores in the S electrode material resulting in intertwining and/or embedding of the BNNT composite component (e.g., BNNT and binder) and within pores on the surface of the electrode component. This results in excellent intimate contact between both components in the protected electrode and indeed the film/coating does not delaminate from the electrode at least under typical cycling conditions.

### S Cathode

In some preferred embodiments, the electrode is a sulfur electrode, e.g., a sulfur cathode for a secondary energy storage device. Thus, in another aspect, the invention provides an electrode for an energy storage device, the electrode comprising a sulfur (S) cathode material having a porous network, mesh or deposit of boron nitride nanotubes (BNNTs) provided on the S-cathode material. The BNNT is a porous network, mesh or deposit is not permeable to polysulfides but allows passage of metal transport ions. The BNNTs may adsorb and/or prevent diffusion of polysulfide into an electrolyte contacting the electrode, for example, as found in an energy storage device. In preferred embodiments, the BNNTs for the S cathode is a composite of BNNTs and at least one polymeric binder.

### Metal Electrodes

The electrode may be a metal electrode, particularly those which suffer from problematic dendrite formation, e.g., aluminium, zinc or an alkali metal electrode for example, lithium, sodium or potassium, which involve transport metal ions of those metals. In some preferred embodiments, the electrode is a metal or metal-based electrode for an energy storage device having a composite of boron nitride nanotubes (BNNTs) and polymer binder provided on at least one surface of the electrode as a porous network which is selectively permeable to transport metal ions used in the energy storage device. The BNNT or BNNT/polymer binder composite is particularly useful for lithium electrodes.

Desirably, the composite BNNT porous network or porous mesh is flexible and resists cracking or breaking during cycling in an energy storage device during normal operation which will be understood to mean charging/discharging at a current density range of from 0.1 mA cm⁻² to 20 mA cm⁻². Such BNNT network or mesh flexibility may be demonstrated as stable electrochemical metal stripping or plating, for example, in a symmetrical cell or stable charge and discharge cycling over multiple cycles in an energy storage device, compared to an equivalent system without the BNNT porous network or porous mesh on the electrode. By multiple cycles, it is meant greater than at least 100, at least 500 or at least 1000, stripping/plating cycles in galvanostatic cycle testing or greater than 100 at least 500 or at least 1000, charge/discharge cycles in a battery cell.

Suitably, the BNNT porous network or porous mesh better controls undesirable electrode, particularly metallic based anode material, volume expansion which occurs on cycling in a cell compared to an equivalent electrode, particularly a metallic based anode material, without the BNNT porous mesh on the electrode. The BNNT mesh is thought to protect and reinforce an SEI formed between the metal electrode and the SEI on cycling. Furthermore, in an electrode, particularly a metal anode without the BNNT component, volume expansion occurs at different areas of the electrode to varying degrees, depending on where metal ion flux reaching the electrode surface concentrates. The composite BNNT component of the invention homogenises this volume expansion by more uniformly directing metals ions across areas of the electrode that contact the BNNT porous component.

In one embodiment, the electrode material is a sulfur-based electrode material. Desirably, the invention provides an electrode for an energy storage device comprising an S-cathode material having a porous network of boron nitride nanotubes (BNNTs), preferably composite BNNT/polymer binder on the S-cathode material. In a related aspect, the invention provides an energy storage device electrode comprising an S-cathode material having a porous network or deposit of boron nitride nanotubes (BNNTs) on the S-cathode material, preferably composite BNNT/polymer binder on the S-cathode material.

In another aspect, the invention provides a metal or metal-based electrode for an energy storage device having a composite of boron nitride nanotubes (BNNTs) and polymer binder provided on at least one surface of the electrode as a porous network which is selectively permeable to transport metal ions used in the energy storage device.

In a related aspect, the invention provides a negative electrode (anode) for an energy storage device, comprising a metallic based anode material, the negative electrode having associated therewith boron nitride nanotubes (BNNTs) in the form of one or more deposits or interlayers of BNNTs having a porous mesh structure.

Preferably, in the case of a sulfur-based electrode, the sulfur is present in the electrode material at an active material loading of from about 0.1 mg cm⁻² to about 5 mg cm⁻², more preferably, from about 0.9 mg cm⁻² to about 2.5 mg cm⁻². In some embodiments, the sulfur is present in the electrode material at an active material loading of from about 3 mg cm⁻², particularly when the BNNTs in the film are at a loading density of about 0.2 mg cm⁻² to about 0.25 mg cm⁻².

Preferably, the deposit is in the form of one or more layers of boron nitride nanotubes (BNNTs) which coat at least one surface of the electrode material.

It will be understood that the electrode is formed into a block or other shaped structure having one or more substantially flat or planar faces onto which the BNNTs can be deposited as the film of composite BNNT porous network or coating of composite BNNT porous mesh.

Suitably, the composite boron nitride nanotubes (BNNTs) component has an average thickness as described herein. The thickness can be determined by SEM analysis. Particularly preferred thicknesses are in the range of from about 1 micron to about 10 microns. About means±2%. Particularly preferred BNNT layer thicknesses are in the range of from about 1 micron to about 5 microns, which in some embodiments have been found to give 79-90% capacity retention with respect to the first cycle. In some embodiments, more preferred BNNT layer thicknesses are in the range of from about 1.3 microns to about 2.5 microns. In other embodiments, further preferred BNNT layer thicknesses are in the range of from about 1.5 microns to about 2.3 microns, which gives an excellent initial specific capacity of between 800 and 1100 mAh g 1 and from 85-90% capacity retention after more than 400 cycles based on the initial capacity at a current density of 0.2 C. In one embodiment, a BNNT layer thickness of about 1.5 microns or 2.3 microns is especially preferred.

Preferably, the boron nitride nanotubes (BNNTs) are present in the network on the sulfur cathode material in an amount ranging from about 50% to about 95% by weight of the network/deposit, more preferably from about 80% to about 90% by weight of the network/deposit.

In one embodiment, the composite BNNT network or mesh is formed on the electrode surface by casting a solvent-based slurry of the BNNTs and binder onto the electrode surface and evaporating the solvent to form the composite BNNT/binder porous network/deposit. Thus in some embodiments the network/deposit is a solvent cast network/mesh which has an excellent interfacial contact between the components with gaps/spaces between the component at the nano level only.

In embodiments, comprising binder in the BNNT network/mesh, it will be understood that the slurry from which the network/mesh is prepared comprises/consists essentially of BNNTs, binder and a solvent. A preferred slurry comprises BNNT (in an amount as described above for the binder concentration) but preferably of from 1 to about 10% by weight of the entire slurry in the solvent, preferably 3-7% wt, most preferably about 5% wt of the entire slurry in the solvent.

Desirably, the S electrode comprises one or more conductivity enhancing agents, preferably carbon-based conductivity enhancing agents to enhance the electrical conductivity of the S material of the electrode. Preferably, the conductivity enhancing agents are one or more graphenes, such as high porosity graphene or high surface area graphene. In one embodiment, a preferred conductivity enhancing agent is a mixture of high porosity graphene and high surface area graphene. A preferred high porosity graphene has a porosity of from 300 m²/g and 800 m²/g, preferably around 400 m²/g. In one embodiment, a preferred high surface area graphene has a surface area of about 800 m²/g to 1000m²/g, preferably around 833 m²/g. In one embodiment, a preferred ratio between high porosity graphene and high surface area graphene is from 1:9 to 9:1, preferably around 6:4.

Preferably, the electrode material, preferably a sulfur-based electrode material, is deposited on a current collector, preferably a metal current collector, more preferably a metal foil current collector, most preferably an aluminium foil current collector. Preferably, when the electrode material is a metal or metal-based electrode material, for example, Li, K or Na, deposited on a current collector, preferably a metal current collector, more preferably a metal foil current collector, most preferably a copper foil current collector.

Also described herein is an energy storage device comprising one or more electrodes of the invention as described herein. In a related aspect, the invention provides an energy storage device comprising one or more negative electrodes as described herein, for example, a lithium metal, potassium metal or a sodium metal electrode.

In a related aspect, the invention provides an energy storage device comprising a metallic based anode material, the negative electrode having associated therewith boron nitride nanotubes (BNNTs) in the form of one or more deposits or interlayers of a composite BNNT/binder porous mesh.

Suitably, a preferred energy storage device comprises at least one cathode having a sulfur-based electrode material having a porous deposit of boron nitride nanotubes (BNNTs) on the electrode material; a separator; and at least one anode having a lithium, potassium or sodium metal-based electrode material on the electrode material; and an electrolyte. Suitably, a preferred energy storage device comprises at least one cathode having a sulfur-based electrode material having a porous deposit of boron nitride nanotubes (BNNTs) on the electrode material; a separator; and at least one anode having a lithium metal-based electrode material on the electrode material; and an electrolyte.

For example, the invention relates to a metal-sulfur energy storage device comprising
at least one sulfur (S) based electrode having a film of a composite of boron nitride nanotubes (BNNTs) and at least one polymeric binder, wherein the film of the composite intimately contacts at least one surface of the electrode as a porous network which is selectively permeable to transport metal ions and electrolyte used in the energy storage device but not polysulfides (impermeable to polysulfides);
at least one metal electrode having a coating of a composite of boron nitride nanotubes (BNNTs) and at least one polymeric binder, wherein the coating of the composite intimately contacts at least one surface of the electrode as a porous mesh which is selectively permeable to transport metal ions used in the energy storage device wherein the composite is physically and/or chemically bonded to the surface of the electrode.

The invention also relates to a lithium-sulfur energy storage device comprising:
at least one sulfur (S) based electrode having a composite of boron nitride nanotubes (BNNTs) and at least one polymeric binder, wherein a film of the composite intimately contacts at least one surface of the electrode as a porous network which is selectively permeable to transport metal ions and electrolyte used in the energy storage device but not polysulfides (impermeable to polysulfides);
at least one lithium metal electrode having a composite of boron nitride nanotubes (BNNTs) and at least one polymeric binder, wherein a coating of the composite intimately contacts at least one surface of the electrode as a porous mesh which is selectively permeable to lithium ions wherein the composite is physically and/or chemically bonded to the surface of the electrode.

Desirably, the energy storage device retains up to 60% of the initial capacity after at least 500 cycles at a current density of 0.2 C.

Desirably, the energy storage device exhibits a specific capacity of at least 400 mAh g⁻¹ based on S loading, preferably exhibiting a specific capacity of at least 900 mAh g⁻¹ based on S loading, at a 0.2 C rate at a temperature of 25° C.

Preferably, the device exhibits a capacity of at least 8 mAh. Preferably, the device exhibits a capacity of at least 24 mAh. Preferably, the device exhibits a capacity of at least 32 mAh.

Described herein is an energy storage device comprising one or more electrodes of the invention as described herein. Desirably, the energy storage device comprises one or more negative electrodes for a secondary energy storage device, for example, a lithium metal or a sodium metal electrode (anode) or zinc or aluminium metal (anode). It will be understood that negative electrode is the electrode at which oxidation occurs during discharge, i.e., the lithium anode in a Li—S battery where lithium dissolution from the anode surface occurs and is incorporated into alkali metal polysulfide salts. That electrode becomes the cathode while charging where lithium is plated on the cathode electrode during charging.

In a related aspect, the invention provides an energy storage device comprising a metallic based anode material, the negative electrode having associated therewith boron nitride nanotubes (BNNTs) in the form of one or more deposits or interlayers of BNNT porous mesh.

It has been found that Li—S cells with BNNTs on the cathode and anode performs substantially better in terms of cycling stability and energy density compared to an identical cell without BNNTs. Indeed, the integration of BNNTs into lithium-sulphur battery components and architecture is an effective method of stabilising the battery components during charge and discharge, creating a lithium sulphur battery cell with a cycle life approaching that of everyday consumer grade lithium-ion batteries. This offers the potential for a lithium-sulphur battery to finally be commercialised and mass produced.

### Electronic Devices

Described herein is an electronic device comprising the electrode of the invention, and/or the energy storage device of the invention.

### Applications/Uses

Described herein is a use of the electronic device of the invention, in transportation, grid storage, electric vehicles, and portable electronics applications.

Described herein is a use of one or more BNNT layers, preferably in the form of a composite BNNTs/polymer binder porous network as a polysulfide blocking material for an S cathode of an energy storage device. Preferred use is of one or more BNNT layers preferably in the form of a composite BNNTs/polymer binder porous network as a polysulfide diffusion blocking coating or a reversible trap for polysulfide in a sulfur (S) based cathode of an energy storage device.

Described herein is a use of one or more BNNT layers, preferably a composite BNNTs/polymer binder porous mesh as a dendrite growth inhibitor on a metal electrode of an energy storage device. Preferred is use of a coating of a composite of boron nitride nanotubes (BNNTs) and at least one polymeric binder as a porous mesh physically and/or chemically bonded to the surface of a metal electrode to prevent dendrite formation on the electrode in an energy storage device, preferably wherein the electrode is a Li, Na, K, Al, Mg, or Zn metal anode. The physical and/or chemical attachment may involve an SEI formed on cycling.

Described herein is a use of one or more BNNT layers, preferably a composite BNNTs/polymer binder porous mesh, as a dendrite growth inhibitor for a metal electrode of an energy storage device. Described herein is a use of one or more BNNT layers, preferably a composite BNNTs/polymer binder porous mesh as a solid electrolyte interface reinforcing material for a metal electrode of an energy storage device.

Preferred is a use of a coating of a composite of boron nitride nanotubes (BNNTs) and at least one polymeric binder as a porous mesh bound to a metal electrode to modify volume expansion of the metal electrode in an energy storage device, preferably a Li, Na, K, Al, Mg, or Zn metal anode. Preferred is a use of a coating of composite of boron nitride nanotubes (BNNTs) and at least one polymeric binder as a porous mesh physically and/or chemically bonded to the surface of to a metal electrode to reinforce stability of a native SEI formed on the electrode in an energy storage device.

### Formation of BNNT Porous Network, Mesh or Deposit

Described herein is a slurry for preparing a composite BNNT porous network or porous mesh for an electrode material comprising boron nitride nanotubes (BNNTs), one or more polymeric binders, and one or more solvents. Suitably, the electrode material is a S cathode material and the BNNTs are provided as a film of a composite of BNNT and binder as a porous BNNT network on the electrode surface. Also described herein is a slurry for preparing a coating of a BNNT mesh preferably a coating of a composite BNNTs/polymer binder porous mesh for a metal or a metallic based anode material comprising boron nitride nanotubes (BNNTs), one or more polymeric binders, and one or more aprotic solvents. Desirably, the solvent is one which is inert to the metal. Suitably, the metal is an alkali metal, particularly sodium or potassium, zinc or aluminium metal.

Described herein is a method of preparing an electrode for an energy storage device, the electrode comprising an electrode material having associated therewith boron nitride nanotubes (BNNTs) in the form of a porous network or porous mesh of composite of BNNTs/polymeric binder, the method comprising the steps of:
(i) preparing a slurry of BNNTs and the one or more polymeric binders in a solvent;
(ii) coating surfaces of the electrode with the slurry in a desired thickness;
(iii) evaporating the solvent to form the BNNT porous network or porous mesh on the electrode.

Described herein is a method of preparing a negative electrode (anode) comprising a metallic based anode material having associated therewith boron nitride nanotubes (BNNTs) in the form of one or more deposits or interlayers of BNNTs having a porous mesh structure, the method comprising the steps of:
(i) preparing a slurry of BNNTs and one or more polymeric binders in one or more solvents;
(ii) coating surfaces of a metallic based anode material with the slurry in a desired thickness;
(iii) evaporating the solvent to form a metallic based anode material having a surface coating of a composite of BNNT having a porous mesh structure. The preferred dimensions are disclosed elsewhere herein. The BNNT concentration in the slurry is 10 wt % or less, preferably 7.5 wt % or less, more preferably 5 wt % or less. The amounts of polymer and thickness is described elsewhere herein. The doctor blade technique can be used to adjust the thickness of the slurry. Preferred thicknesses are described elsewhere herein.

### DESCRIPTION OF PREFERRED EMBODIMENTS

The present invention is described with reference to the following embodiments examples. It is to be understood that the examples are illustrative of and not limiting to the invention described herein.

### Embodiment 1—a Film of BNNT Network Prevents Polysulfide Shuttle

Owing to their extraordinary thermal, mechanical, optical, and electrical properties, boron nitride nanotubes (BNNTs) have been attracting considerable attention in various scientific fields, making it more promising as a nanomaterial compared to other nanotubes. However, boron nitride nanotubes (BNNTs) have never been demonstrated as a useful polysulfide-blocking material in S-cathodes of batteries, particularly Li|S batteries.

Herein described are composite boron nitride nanotubes/binder films or coatings provided on an electrode surface. In the case of S cathode electrodes, the BNNTs is provided as a film of a BNNT porous network. In the case of a metal anode electrode, the BNNTs is provided as a coating of a BNNT porous mesh. The different terminology signifies differences in the thickness and density of the respective BNNT component. For the S cathode, a dense network of BNNTs is required to prevent PS diffusion through the network into the electrode, yet the thickness is such that the PS is reversibly trapped in the network, that it so that it is not permanently trapped in the network resulting in inactive sulfur and significant loss of capacity/capacity face over time. Likewise, with the metal anode coating of the BNNT porous mesh is of a thickness that is suitable for reinforcing the SEI of a metal anode while allowing efficient metal ion transport through the mesh. The mesh actually serves to segment the metal electrode surface into areas to which the ions can be more evenly distributed on passing though the mesh.

The cycling performance of Li—S coin cells and pouch cells with and without BNNT interlayers on the cathodes have been studied in detail. The results clearly show a BNNT interlayer can significantly improve the cycling stability of the Li—S batteries evidencing performance of the interlayer in controlling the polysulfide shuttle and mitigating adverse effects resulting from polysulfide shuttling. Li—S coin cells and Li—S pouch cells incorporating the BNNT/S-cathodes of the invention were prepared. In some embodiments the studies examine the electrochemical lithium plating and stripping behaviour in a cell having a lithium metal anode and a S-cathode whereby the S-cathode is protected from cathode mass loss through polysulfide shuttle by providing a composite BNNT-binder network or deposit according to the invention on top of the S cathode. It is believed that the BNNT interlayer, when provided in a suitable thickness and/or density, can both act as a physical barrier to block polysulfides shuttle and/or to adsorb polysulfide thereon to prevent its diffusion to the electrolyte. However, the preferred porous BNNTs described herein comprise channels or pathway for transport of lithium ions, leading to a high cycling stability and a high capacity.

In particular, the invention provides a cathode comprising a sulfur-cathode material having associated therewith a porous film or a porous deposit of boron nitride nanotubes (BNNTs). Preferred S cathode material also include graphene. The porous nature of the film or deposit can be observed from SEM analysis which the porous nature of the BNNT material is clear. The average pore diameter of the pores in the BNNT material is preferably about 0.1 to 3 microns, more preferably about 0.5 to 1.5 microns. The boron and/or nitrogen components of the film/deposit can be confirming with EDS analysis.

Preferably, the boron nitride nanotubes (BNNTs) film/deposit has tunnels, pathways or channels therethrough which are arranged and/or dimensioned to allow passage of Li ions but not polysulfides including Li₂S₄ or Li₂S₆. As shown by the Raman and IR studies described herein, the BNNT film/deposit block passage of polysulfides through the film/deposit. It is believed that the polysulfides adsorb onto the BNNTs. The adsorption therefore prevents diffusion of the polysulfide to the electrolyte.

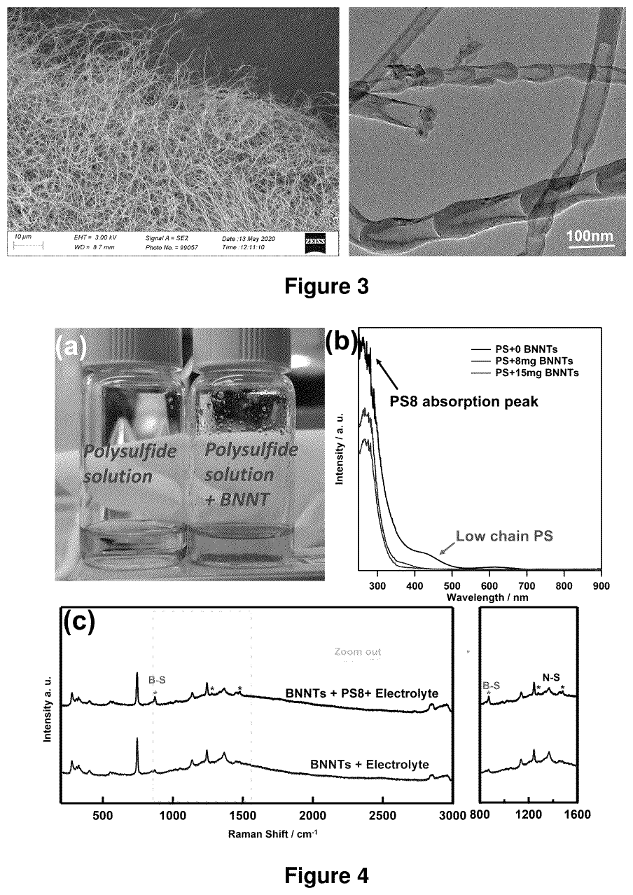

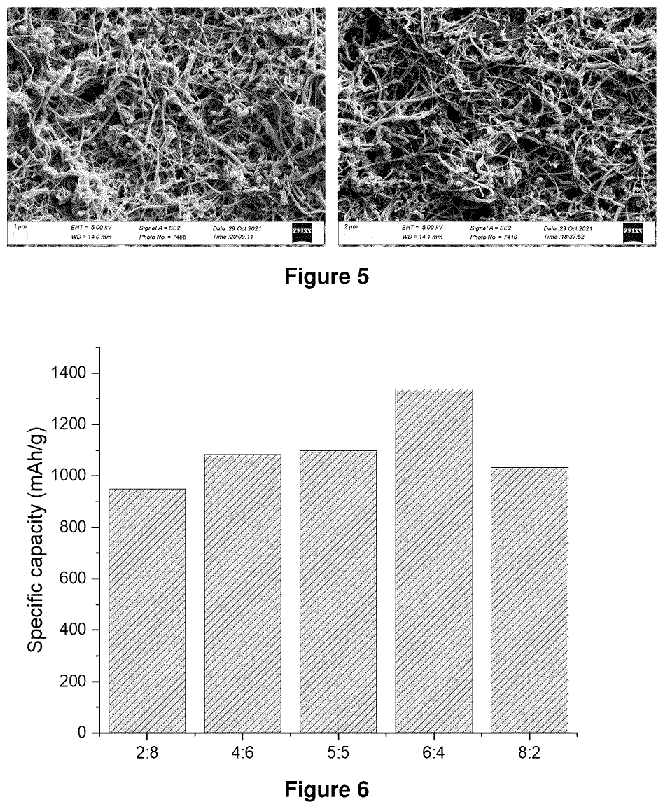

In some embodiments, the BNNTs used have an average diameter of from about 10 nm to about 250 nm, preferably from about 20 to 150 nm. In some embodiments, the BNNT used have an average length from about 1 micron to about 200 microns, more preferably about 3 microns to about 100 microns. In other embodiments, the length is at least 0.5 microns, more preferably at least 1 micron, more preferably still at least 10 microns. As can be seen from the SEM and TEM images of the BNNT in the FIG. 3, the diameters of many of the BNNTs are mostly 20-150 nm and the lengths are mostly 3-100 microns.

Desirably, the BNNT film/coating is of a mixture of BNNT and one or more binder materials. Suitably, the BNNT porous mesh/network or deposit comprises at least one binder material, preferably a polymeric binder. In a preferred embodiment, binder is present and suitably is a polymer binder or a mixture or two or more polymeric binders. The binder supports structural formation and integrity of the BNNT porous mesh/network or deposit. Polymeric binders are particularly preferred as they possess inherent flexibility under typically energy storage device conditions which is desirable in terms of imparting controllable flexibility to the BNNTs structure. In a preferred embodiment, the boron nitride nanotubes (BNNTs) network/deposit further comprises one or more binders. Preferably, the binder is a polymeric binder, such as PVDF, LA133, PEO or PTFE or combinations thereof. These examples of binders are particularly preferred for a BNNTs for a S cathode type electrode. In other embodiments, preferred binders are those that are chemically and/or physically stable in the present of the metal or metal-based electrode in question, particularly Li metal, K metal or Na metal which are inherently very reactive materials. Though not essential to the functioning of the BNNT porous mesh of the invention, preferred polymeric binders may be permeable to the metal ion in question. In some embodiments, the flexible polymeric binder is preferably a natural or synthetic rubber, most preferably a styrene butadiene rubber such as poly(styrene-co-butadiene). These examples of binder are particularly preferred for metal anodes such as lithium, potassium or sodium.

Preferably, the binder is present in an amount ranging from ranging from 1% to 50% or 5% to 50% by weight of the boron nitride nanotubes (BNNTs) network/deposit. Binder concentration of 1% to 15% by weigh are preferred in some embodiments. In some preferred embodiments, the binder is present in an amount ranging from 10% to 20% by weight of the boron nitride nanotubes (BNNTs) network/deposit. In some particularly preferred embodiments, the binder concentration is 1, 2, 3, 4, 5, 6,7 ,8, 9,10, 11, 12, 13, 14, or 15 wt % binder to the total BNNT component. Most preferably the binder is present in the BNNT/binder composite at 10 wt % or less, 9 wt % or less, 8 wt % or less, 7 wt % or less, 6 wt % or less, 5 wt % or less, 4 wt % or less, 3 wt % or less, 2 wt % or less, or 1 wt % or less. At a minimum, in embodiments involving a BNNT/binder composite, a minimum of 0.5 wt % of binder is present.

Preferably, the boron nitride nanotubes (BNNTs) are present in an amount ranging from about 50% to about 98% wt, more preferably 80% wt to 95% wt, more preferably 85% wt to 95% wt of the boron nitride nanotubes (BNNTs) film or deposit. In some embodiments, the boron nitride nanotubes (BNNTs) are present in an amount of 85% wt, 86% wt, 87% wt, 88% wt, 89% wt, 90% wt, 91% wt, 92% wt, 93% wt, 94% wt, 95% wt of the total film/deposit. In other preferred embodiments, the boron nitride nanotubes (BNNTs) are present in an amount ranging from about 88% to about 93% wt BNNT of the total weight of the film/deposit, preferably about 90% by weight. ‘About’ means±1% of the stated value. Suitably, the remainder % is binder.

Preferably, at least a portion of, preferably a majority of, the binder in the composite BNNT network/deposit is in particulate form. Preferably, binder particles are dispersed (preferably homogenously) throughout the composite BNNT/binder network/deposit. Binder dispersion can be confirmed by SEM analysis where distinct particles (typically spherical or generally spheroidal particles) of the binder are observed to be homogeneously dispersed amongst the BNNT network, that is the BNNT fibres/strands forming the network. The contrasting morphologies between the binder particles and the BNNT fibres/strands means the binder and BNNTs may be easily distinguished on SEM analysis. Desirably, the binder particles adhere or otherwise fix localised areas or regions of the BNNTs fibres/strands together to provide stability and yet flexibility to the structure of the porous network. It will be understood that the binder particles fix one or more BNNT fibres/strand together in the location where the binder particles are located. Desirably, the binder does not to any significant degree coat the surfaces of, or encapsulate, the BNNTs fibres/strands for example in a conformal film of polymer to any degree that would negatively affect the porosity/pore diameter particularly a typically battery operating temperatures or even during thermal runaway. In the present invention, it is desired that the porosity of the network always be preserved, even when the network/deposit subjected to heat for example which occurs during energy storage device operation. This is in contrast to the BNNT-polymer composites of US 2019/0123324 in which the opposite result is desired and the polymer is provided not in particular form, but as a film/coating on the BNNT scaffold where by on experiencing abusive temperatures, the polymer coating expand to reduce separator pore sizes or indeed to close the pores entirely to prevent thermal runaway.

During film/deposit preparation, where an organic solvent system is used to prepare the BNNT/binder mixture, a preferred binder used is PVDF. In some embodiments of cathode preparation, a higher mass loading of sulfur can be obtained with water-based system. Therefore, where an aqueous solvent system is used to prepare the BNNT/binder mixture, a preferred binder used is LA133 (an acrylonitrile multi-copolymer binder). SEM studies indicate that irrespective of the solvent system/binder used, the porous structure and/morphology of the film/deposit is the same. For example, FIG. 8 shows the films/deposit using LA133 and PVDF have essentially the same structures and morphologies despite the different binders used. In cases where binder is used in the S cathode, the same or different binder can be used in the BNNT film/deposit. For example, where the S cathode is prepared in aqueous solution, LA133 may be used as cathode binder. In the case where an organic solvent is used to form the S cathode, PVDF can be used in cathode and in the BNNT film/deposit.

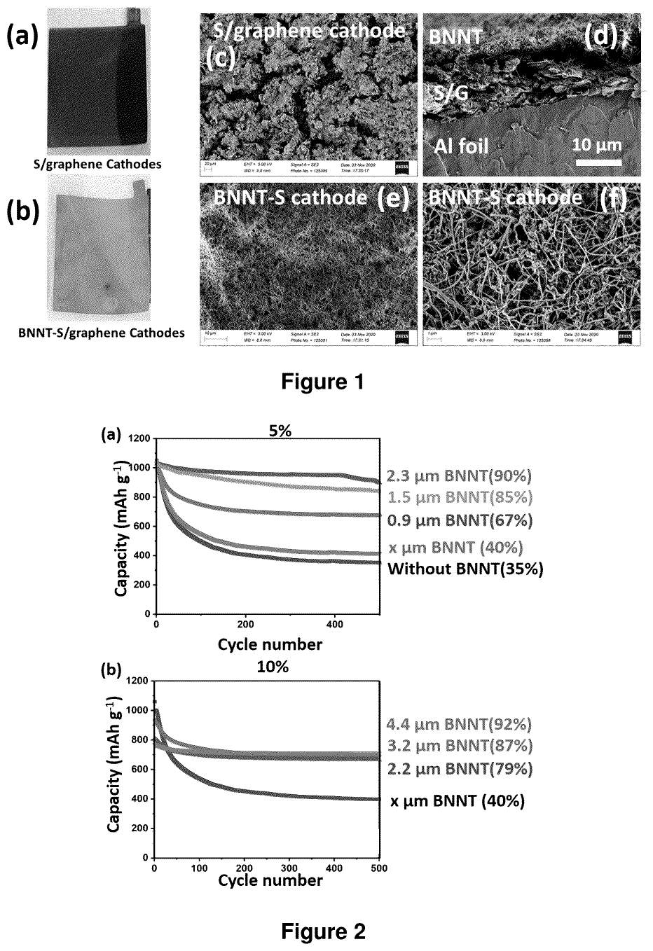

In some embodiments, the boron nitride nanotubes (BNNTs) are in the form of a standalone or free-standing film positioned proximate to the cathode. However, in other preferred embodiments, the film is not a standalone or free-standing film in that the BNNT film/deposit intimately contacts/rest against the S cathode. In some embodiments, the BNNT film/deposit adheres to the S cathode material. It is believed that on casting the BNNT/polymer slurry during manufacture, the BNNT/polymer material infiltrates pores of the S electrode surface to some degree. On evaporation of the solvent to form the film, this results in a strong adherence between the BNNT/composite film and the S electrode material. In any case, there is at least some, and preferably complete, interfacial contact directly between the BNNT film/deposit and the S cathode material. See for example FIG. 1(d) which shows a preferred arrangement and intimate interfacial contact of the film of BNNT porous network with the S cathode material.

The morphology of the BNNT interlayers has been investigated with SEM. The thickness of the BNNT interlayer used can be controlled, for example, in the case of a coating on the cathode material by a combination of (i) adjusting the concentration of BNNTs in the interlayer slurry used during formation, and (ii) adjusting the height of a doctor blade used to form an even coating after a slurry comprising the BNNTs is applied to a S-cathode material.

The concentration of BNNT in the slurry affects the density/loading of the BNNT in the final film when formed. In some embodiments, it is preferred to use a BNNT concentration in the slurry of 15 wt % or less, 10 wt % or less, 7.5 wt % or less, or 5 wt % or less. In some embodiments, a BNNT concentration in the slurry of about 5 wt % is preferred. (“About” here means±5%).

The morphology can be described as a disordered network, mesh or sieve of filaments or strands of BNNTs (depending on the BNNT density/loading used), for example having a plurality of filaments or strands arranged in the form of a felt or a web. The morphology adopts a tunneled, random, fibrous web, honeycomb or fibre felt type structure which arises from the random over lay of twisted, tangled, ad/or distorted yarn threads or fibrils which are formed from bundles of the BNNT nanotubes and result in a structure having channels, pathways or tunnels therethrough dimensioned to allow Li ion transport therethrough but not polysulfides. The BNNT porous network/mesh comprises intersecting filaments or strands of BNNTs, a network or grid of connected, contacting or intersecting filaments or strands of BNNTs, particularly entangled, intersecting, interlaced or intertwined filaments of BNNTs. In short, the BNNT yarn, threads or fibrils are not straight and are not arranged in an ordered, repeating or regular array type of structure or arrangement.

### S-Cathode Electroactive Material Compositions

In one embodiment the invention provides a sulfur (S) based cathode comprising a sulfur-cathode material having associated therewith a porous film of boron nitride nanotubes (BNNTs).

Suitably, the invention provides for a sulfur (S) based electrode for an energy storage device having a film of a composite of boron nitride nanotubes (BNNTs) and at least one polymeric binder, wherein the film of the composite intimately contacts at least one surface of the S electrode as a porous network which is selectively permeable to transport metal ions and electrolyte used in the energy storage device but impermeable to polysulfides. It should be understood that the film of composite has tunnels, pathways or channels therethrough dimensioned to allow selective passage of the transport metal ions through the porous network while reversibly trapping polysulfide in the porous network.

When the film of BNNT porous network is used to protect a S electrode material, the density of the BNNTs is such the channels, pathways or tunnels reversibly trap polysulfide. However, the density/thickness of the film of BNNT porous network is not significant enough to irreversibly trap polysulfide as this would be undesirable since it leads to inactivation of the active electrode material and thus a loss of capacity over time. The density/thickness of the film of BNNT porous network is selected such that the S can, on cycling, be driven back to contact the active cathode mass such that it retains electrochemical activity despite the mesh. Preferred densities/thickness are described elsewhere herein.

It will be understood that the S-cathode comprising an electroactive material composition comprising sulfur as the electrochemical active. In some embodiments, the sulfur is present in an amount ranging from about 60% to about 99% by weight of the electroactive material composition. Amounts ranging from about 70% to about 90% by weight are preferred. In one embodiment, 80% by weight sulfur is particularly preferred. Suitably, the thickness of the sulfur/graphene cathode ranges from about 5 microns to about 40 microns.

Preferably, the S-cathode also comprises a conductivity enhancing material, preferably a carbon-based conductivity enhancing material, for example, carbon black, carbon nanotubes (CNTs), carbon nanoparticles, or graphene. In preferred embodiments, the cathode material may comprises one more conductivity enhancing agents, such as carbon black (e.g., an electroconductive carbon black such as Ketjen black) or graphene. In some embodiments, the S cathode consists essentially of sulfur and the one more conductivity enhancing agents. In some embodiments, the conductivity enhancing material is present in an amount ranging from 5% to 30% by weight of the electroactive material composition. In some embodiments, the conductivity enhancing material/agents can be present from 10 to 30 wt % of the cathode. In one embodiment, 26% by weight ratio is particularly preferred. Graphene is a particularly preferred conductivity enhancing material. Desirably, wherein conductivity enhancing agent is one or more graphenes, the material may be present in an amount of from about 0.2 mg cm⁻² to about 0.8 mg cm⁻² about 0.4 mg cm⁻² to about 0.7 mg cm⁻² about 0.5 mg cm⁻² to about 0.6 mg cm⁻². In some embodiments, the mass loading of graphene in the cathode is 0.6 mg/cm². The graphene can be a single type or graphene or a mixture of two or more types of graphene, for example highly porous graphene and high surface area graphene. Suitably, the electroactive material composition may comprise a mixture of highly porous graphene and high surface area graphene for example in a %weight ratio of from 1:9 to 9:1, more preferably 3:7 to 8:2, more preferably, 4:6 to 7:3, most preferably 6:4 by weight ratio is particularly preferred. Suitably, the ratio between high porous graphene and high surface graphene is 6:4 as this provided particularly good performance in terms of highest specific capacity. FIG. 6 shows the effect of a variety of ratios on the specific capacity. Therefore, the weight ratio of a preferred composition is 12 wt % high porous graphene:8 wt % high-surface graphene: 80 wt % sulfur. Thus, in one preferred embodiment, the cathode electroactive material composition comprises 12 wt % high porous graphene:8 wt % high-surface graphene: 80 wt % sulfur.

Preferably, the sulfur is present in the electrode material at an active loading of from about 0.1 mg cm⁻² to about 10 mg cm⁻², 0.5 mg cm⁻² to about 7.5 mg cm⁻², about 0.9 mg cm⁻² to about 6 mg cm⁻², most preferably about 5 mg cm⁻². A desirable electrode has S in the electrode present at a S mass loading of about 1 mg cm⁻² to about 8 mg cm⁻², preferably at about 2.5 mg cm⁻² to about 4.5 mg cm⁻², most preferably at about 3 mg cm⁻². In some embodiments, the mass loading of sulfur in the cathode ranges from about 0.9 to about 2.4 mg cm⁻².

Desirably, the boron nitride nanotubes (BNNTs) film or deposit has a density of from about 0.2 mg cm⁻² to about 1.7 mg cm⁻², more preferably from about 0.1 to about 1 mg cm⁻², more preferably from about 0.5 to about 0.75 mg cm⁻².

In one embodiment, the boron nitride nanotubes (BNNTs) deposit has an average thickness of from about 0.1 microns to about 10 microns. In preferred embodiments, the boron nitride nanotubes (BNNTs) deposit has an average thickness of from about 0.9 microns to about 5 microns, preferably from about 1.5 microns to about 3 microns, more preferably from about 1.75 microns to about 2.5 microns. In some embodiments, an average thickness of about 1.9 microns to 2.3 microns is preferred. In some preferred embodiments, a desirable film of composite has an average thickness of from about 0.9 microns to about 5 microns, preferably from about 1.5 microns to about 3.5 microns, most preferably about 2.5 microns. In some particularly preferred embodiments, the average thickness of about 3.5 microns or less is preferred as this has been found to provide good protection between sufficient protection to avoid rapid capacity loss and ability to prevent the polysulfide shuttle. However, for thicker layers, the trapped/adsorbed polysulfide will be inactive because the BNNT layer is too thick for the PS to go back to the cathode mass so that the capacity drops after the first and second cycles. For example, the cycling stability results of a single later 2.1 V Li—S pouch cells with different thickness of BNNT layers on the S cathode show a very high capacity retention (≥90%) after 50 cycles at 0.2 C at a temperature of25 ° C. in the case of a 2.3 micron thick BNNT interlayer and a good a capacity retention (≥80%) after 50 cycles at 0.2 C in the case of a 0.9 micron thick BNNT interlayer. This is a significant improvement over an equivalent pouch without the interlayer which exhibits a capacity retention of about 65% after 50 cycles.

In one embodiment, the boron nitride nanotubes (BNNTs) film/deposit has a BNNT loading density of from about 0.075 mg/cm² to about 0.5 mg/cm². In preferred embodiments, the boron nitride nanotubes (BNNTs) film/deposit has a BNNT loading density of from about 0.1 mg/cm² to about 0.3 mg/cm², preferably from about 0.15 mg/cm² to about 0.25 mg/cm². A desirable film of composite has an areal density or BNNT loading of from about 0.05 mg cm⁻² to about 3.5 mg cm⁻², more preferably from about 0.05 to about 0.5 mg cm⁻², most preferably 0.2 mg cm⁻². The range of about 3.5 mg cm⁻² or less is particularly preferred when longer cycling life is desired as the film/deposit is dimensioned so that adsorbed polysulfide can efficiently return to the cathode mass on cycling, i.e. it remains active. About means±2%. In some embodiments, the boron nitride nanotubes (BNNTs) film/deposit has a BNNT loading density of about 0.2 mg/cm² as this has been found to give particularly good capacity retention of over 90% of the initial capacity, over at least 10 cycles, at least 20 cycles, at least 50 cycles, at least 200 cycles, at least 1000 cycles.

Desirably, the sulfur-based electrode material is deposited on a current collector, preferably an aluminium foil current collector. In some embodiments, the current collector is a metal (e.g. aluminium) foil current collector which may be coated on one or more sides with a conductive material, such as carbon.

The invention relates to an energy storage device (e.g., a secondary battery) comprising one or more cathodes of the invention as described herein. In some embodiments, the device may be a coin cell. In other preferred embodiments, the device may be a pouch cell, such as a single-layer pouch cell. More complex cell arrangements are also envisaged.

In one embodiment, the invention provides an energy storage device comprising one or more sulfur (S) based electrodes of the invention as described herein. For example, the energy storage device may further comprise a separator; at least one metal anode, preferably a lithium or sodium metal anode; and an electrolyte.

In one embodiment, the energy storage device of the invention comprises at least one cathode having a sulfur-based electrode material having a porous film of boron nitride nanotubes (BNNTs) on the electrode material; a separator; and at least one anode having a lithium metal-based electrode material; and an electrolyte.

In preferred embodiments, the energy storage device of the invention retains up to and including 60% of the initial capacity after at least 500 cycles at a current density of 0.2 C at a temperature of 25° C.

In other embodiments, the device retains up to and including 60%, up to and including 70%, up to and including 80%, up to and including 90%, up to and including 100% of the initial capacity after at least 500 cycles at a current density of 0.2 C at a temperature of 25° C. In other preferred embodiments, the device retains up to and including 90%, 91%, 92%, 93%, 94%, 95%, 96%, 97%, 98%, 99% or 100% of the initial capacity after at least 500 cycles at a current density of 0.2 C. These capacity retentions are observed at a temperature of 25° C.

Preferably, the energy storage device exhibits a specific capacity of at least 400 mAh g⁻¹ based on S loading, preferably exhibiting a specific capacity of at least 900 mAh g⁻¹ based on S loading, at a 0.2 C rate at a temperature of 25° C.

The invention also relates to an electronic device comprising a cathode of the invention as described herein and/or an energy storage device of the invention as described herein.

The invention also relates to the use of an electronic device and/or energy storage device of the invention in transportation, grid storage, electric vehicles, and advanced portable electronics applications.

The invention relates to the use of one or more BNNT layers as a polysulfide blocking coating in a cathode of an energy storage device. The invention also relates to use of one or more BNNT layers, preferably BNNT/polymeric binder composite layers, as a polysulfide diffusion blocking coating or a reversible trap for polysulfide in a sulfur (S) based cathode of an energy storage device.

The invention further extends to a metal-sulfur energy storage device comprising
at least one sulfur (S) based electrode having a film of a composite of boron nitride nanotubes (BNNTs) and at least one polymeric binder, wherein the film of the composite intimately contacts at least one surface of the electrode as a porous network which is selectively permeable to transport metal ions and electrolyte used in the energy storage device but is impermeable to polysulfides;
at least one metal electrode having a coating of a composite of boron nitride nanotubes (BNNTs) and at least one polymeric binder, wherein the coating of the composite intimately contacts at least one surface of the electrode as a porous mesh which is selectively permeable to transport metal ions used in the energy storage device wherein the composite is physically and/or chemically bonded to the surface of the metal electrode.

The invention also extends to a lithium-sulfur energy storage device comprising
at least one sulfur (S) based electrode having a composite of boron nitride nanotubes (BNNTs) and at least one polymeric binder, wherein a film of the composite intimately contacts at least one surface of the electrode as a porous network which is selectively permeable to transport metal ions and electrolyte used in the energy storage device but is impermeable to polysulfides;
at least one lithium metal electrode having a composite of boron nitride nanotubes (BNNTs) and at least one polymeric binder, wherein a coating of the composite intimately contacts at least one surface of the electrode as a porous mesh which is selectively permeable to lithium ions wherein the composite is physically and/or chemically bonded to the surface of the metal electrode.

### Detailed Description of Protected S Cathode Electrode

### S Cathode Preparation

First, graphene and sulfur are mixed and then heated at 300° C. The resultant mixture may then be heated, preferably in an airtight container, for example, at 300° C. for about 24 hours to synthesis the S-cathode. Second, the obtained graphene/sulfur powder after being heated mixed with binder, carbon black in an organic solvent, NMP, to form a slurry. Thus, the S-cathode is prepared by mixing the desired amount of sulfur, binder and conductivity additive in the organic solvent, for example, N-Methyl-2-pyrrolidone (NMP). The graphene/binder/sulfur slurry is then coated on a suitable current collector, for example, Al foil with a doctor blade. The thickness can be controlled by adjusting the height of the blade. The S-cathode is then dried in the oven at 80° C. for 12 h and is then ready for coating or otherwise associating with a BNNT interlayer.

### Preparing a Film of a BNNT Porous Network for a S Cathode

The BNNT porous network comprises boron nitride nanotube (BNNT) and binder. For the S cathode, the BNNT composition may comprise from about 1% by weight to about 20% by weight of BNNT of the total BNNT composition. Amounts ranging from about 2% by weight to about 15% by weight of BNNT are preferred. Amount ranging from about 5% by weight to about 10% by weight of the total BNNT interlayer composition are preferred. In one embodiment, an amount of about 5% by weight BNNT of the total BNNT interlayer composition is particularly preferred. In one embodiment, an amount of 10% by weight binder is particularly preferred, for example 10% by weight PVDF of the total BNNT interlayer composition. Preferred BNNTs are obtained from BNNT Technology Limited. The preferred BNNTs are substantially free of impurities such as hexagonal boron nitride and/or elemental boron. The BNNT composition may further comprise one or more binder materials selected from the group consisting of PVDF, PTFE, polyethylene oxide (PEO) and LA133. In some embodiments, LA133 is particularly preferred as it can be used with aqueous solvents/systems such as water.

Notably, the BNNT composite is an electrically insulating material, that is, it is not electronically conductive. Furthermore, the BNNT composite of the invention are free of conductivity enhancing agents, such as carbon-based conductivity enhancing agents, such as graphene. Conductivity enhancing additives are not required, as in the porous BNNT composites, pathways for the transport metal ions such as sodium or lithium ion, are open and preserved during battery operations, therefore, graphene is not needed in the composite to enhance conductivity.

The BNNT interlayer is prepared by mixing the desired amount of BNNTs and the desired amount of binder in a suitable organic solvent such as N-methylpyrrolidinone (NMP) or alternatively deionised water, to form a slurry. The resultant slurry is then coated onto the surface of the cathode electrode material, the thickness of the slurry coating is adjusted as desired, for example, by doctor blading, prior to being dried, for example, in an air oven for 24 h at 60° C. to remove the solvent to provide the final film of BNNT porous network on the S cathode material in the form of a film of <20 microns thickness.

### Current Collector

The current collector may be any current collector suitable for us with a S-cathode. For example, the current collector may a metal foil, such as an aluminium foil or an aluminium foam or a conducting carbon cloth. Suitably current collector thicknesses range from about 10 microns to about 100 microns. In one embodiment, a preferred current collector thickness is about 20 microns, such as a 20 micron aluminium foil. Standard materials can be as the current collector for the Li metal anode, for example, copper foil, for example about 20 microns, such as a 20-micron copper foil.

### Separator

The separator may be any separator suitable for us with a S-cathode. For example, polypropylene separators such as a Celgard 2400 separators (a 25-micron separator) may be used.

### Electrolyte

The electrolyte may be any electrolyte suitable for us with a desired cell under consideration. For example, for a Li—S cell, aDOL/DME combination may be used, particular with Li ionic liquid salts and ionic Li salts such as LiNO₃, wherein suitably, the weight ratio of LiNO₃ can be up to 5%. For example, one exemplary electrolyte is 1 M LiTFSI in DOL/DME with 1 wt % LiNO₃.

### Pouch Material

The pouch material may be any material suitable for us with a Li—S cell, including Al-plastic film.

### Coin Cells Comprising the BNNT/S-Cathodes

Li—S based coin cells comprising Li metal anode, separator, the BNNT protected S-cathode of the invention and electrolyte were fabricated. In one embodiment, standard lithium metal chips for coin cells were used as the lithium metal anode, a 25-micron polypropylene based separator, e.g., a Celgard 2400 separator, was used along with the BNNT/S-cathodes of the invention. The coin cells were filled with an electrolyte compositions of 1 M LiTFSI in DOL/DME with 1 wt % LiNO₃.

Full cells, that is Li—S pouch cells were fabricated in an argon-filled glovebox using lithium metal films as anode, a 25-micron polypropylene-based separator, e.g., a Celgard 2400 separator, and graphene/S cathodes protected with BNNT interlayers. Commercial soft Al plastic films were used as the cases. The electrolyte, e.g., 1 M LiTFSI in DOL/DME with 1 wt % LiNO₃, was appropriately added according to the mass of the sulfur, for example, at a volume corresponding to from about 5 μL/mg to about 50 μL/mg, more preferably about 15 μL mg⁻¹.

### Detailed Description of the Invention

Turning now to FIG. 1 illustrates SEM images of S/graphene cathodes with BNNT composite (FIG. 1b) and without BNNT composite (FIG. 1a) on the sulfur/graphene cathodes. FIG. 1(c) is a high magnification top-down view of sulfur-graphene cathode wherein the porosity in the surface of the S cathode material is evident.

FIG. 1(d) is a side-view image showing three distinct layers of material: (i) BNNT composite component, (ii) sulfur/graphene composite component and (iii) aluminium foil current collector. FIGS. 1(e, f) are low and high magnification top down images of an S cathode provided with a film of a composite of BNNT porous network.

It is clear from FIG. 1(a) and FIG. 1(e) and (f), it is clear that the BNNT porous network covers the entirety of the cathode material. The magnified view in FIG. 1(f) clearly illustrates the BNNT porous network formed by the deposited BNNT interlayer. The morphology can be described as a random, fibrous web, honeycomb or fibre felt type structure which arises from the random over lay of twisted, tangled, ad/or distorted yarn threads or fibrils which are formed from bundles of the BNNT nanotubes. In short, the BNNT yarn, threads or fibrils are not straight and are not arranged in an ordered, repeating or regular array type of structure or arrangement. Distinct homogenously dispersed solid spheroidal binder particles can also be observed in this image.

A comparison of the specific capacity (mAh g⁻¹ based on S) as well as the specific capacity retention (%) achievable with Li—S coin cells comprising the BNNT/S-cathodes versus equivalent Li—S coin cells without the BNNT interlayer on the S-cathode is shown in FIG. 2(a) and FIG. 2(b).

FIG. 2a and FIG. 2b shows performance of the coin cells with BNNT interlayers of 5% and 10% weight ratio to total slurry solution. For the Li—S coin cells in FIG. 2(a), the BNNT interlayers were made using a slurry where the weight ratio of the BNNT is 5%. All the coin cells and pouch cells are tested under 0.2 C at room temperature of about 25 degrees C. Varying the doctor blade height resulted in BNNT interlayer of varying thickness of X microns (X means the coating not reliably measurable as the thickness varies across coating), 0.9 microns, 1.5 microns, and 2.3 microns, which gave corresponding capacity retention (indicate as a % of starting specific capacity) of 40%, 67%, 85% and 90% respectively at 500 cycles as shown in FIG. 2(a). Likewise, in FIG. 2(b), data is shown for cathodes having BNNT interlayers which were made using a slurry where the weight ratio of the BNNT is 10%. Varying the doctor blade height resulted in BNNT interlayer of varying thickness of X microns (X means the coating not reliably measurable as the thickness varies across coating), 2.2 microns, 3.2 microns, and 4.4 microns, which gave corresponding capacity retention (indicate as a % of starting specific capacity) of 40%, 79%, 87% and 92% respectively at 500 cycles as shown in FIG. 2(a). The data suggests a synergy between optimum thickness and optimum BNNT concentration in the slurry. In particular a 2.3 micron film formed from a 5 wt % BNNT slurry gave particularly good capacity over the duration of the cycle study. Further, when the surface of the BNNT coating sulfur cathode was examined with SEM (not shown) it is evident that the sulfur cathodes are not totally covered when the height of the blade is 100 μm and undesirably large particle aggregations can be found on the surface of the BNNT interlayer made with the weight ratio of 10%. Thus there is aggregation on the surface of the BNNT interlayer when a slurry with a BNNT weight ratio of 10% is used. Because of the aggregation, the initial capacity of the cathodes with BNNT coating (10%) is not as high as the capacity of the equivalent cathode without coating. Notably, for the BNNT films used in the experiments reported in FIG. 2(a), there is almost no aggregation observed on the surface of the BNNT interlayer (5%), which contributes to the high initial capacity. If the BNNT thickness goes up to 10 or 20 μm, the capacity retention is good, but the capacity becomes lower, which is understood to be because the tunnel/pathway length for the lithium ion transport is longer in thicker films. In summary, it has been found that thicker BNNTs layers give lower initial capacity but better cycling stability. However, it is found that cycling stability is improved with increasing thickness of the BNNT layer. Depending on a particular desired battery application the resultant performance parameters can be adjusted as required.

### Description of Preferred Embodiment

Synthesis of the graphene/sulfur cathodes: A mixture consisting of 12 wt % high porous graphene, 8 wt % high-surface graphene (Graphene Supermarket, USA), and 80 wt % sulfur was heated at 300° C. in an airtight container for 24 h for synthesizing the graphene/sulfur electrode. The graphene/sulfur is coated on the 20 μm-thick Al foil. The as-obtained graphene/sulfur cathodes were then dried in a vacuum oven at 60° C. for 48 h. These electrodes were further coated with an BNNT interlayer.

Synthesis of the BNNT interlayers on the cathodes: The BNNT interlayer was prepared by mixing 5 wt % BNNT (BNNT Technology Limited) and 0.5 wt % PVDF binder of N-methylpyrrolidinone (NMP) solution. The slurry was coated onto the surface of the graphene/sulfur cathode electrode in a desired thickness by doctor blade and dried in an air oven for 24 h at 60° C.

Fabrication of Li—S coin cells and pouch cells: The lithium chips, Celgard 2400 separators, and graphene/S cathodes with BNNT interlayers were used to fabricate the Li—S coin cells. The electrolyte was 1 M LiTFSI in DOL/DME with 1 wt % LiNO₃.

The fully flexible Li—S pouch cells were fabricated in an argon-filled glovebox using lithium films, Celgard 2400 separators, and graphene/S cathodes with BNNT interlayers. Commercial soft Al plastic films were used as the cases. The electrolyte was appropriately added according to the mass of the sulfur, in this case 15 μL mg⁻¹.

Results and discussion for protection of S cathode: To coat BNNT interlayers on the sulfur cathodes, a slurry which consists of the BNNT, binder and organic solvent is prepared as exemplified above. In this example, the weight ratio of BNNT (weight of BNNT to total weight of the slurry) is controlled to 5%. The height of the blade is also adjusted to 100 μm, 200 μm, 300 μm and 400 μm to control the thickness of the BNNT interlayer formed. On removal of the solvent, the final formed interlayer thickness ranges from 0.9 μm to 5 μm depending on the starting concentration of BNNT in the slurry used.

It can be observed by SEM that the sulfur cathodes are totally covered and a porous network of BNNT interlayer is formed. Three individual layers of components can be observed by SEM in FIG. 1d, which, as shown, are BNNT interlayer, graphene/sulfur layer and Al foil.

The Li—S coin cell with the obtained BNNT interlayer coated sulfur cathodes were fabricated and tested. The cycling stability of the coin cells were investigated in detail. FIG. 2a and FIG. 2b compares the specific capacity of the Li—S coin cells with and without BNNT interlayer coated sulfur cathodes. The BNNT interlayers are made with the slurry where the weight ratio of the BNNT is 5%. At first, the Li—S coin cell without BNNT interlayers demonstrate the worst stability. The cell with the thinnest layer of BNNT layer (note thickness cannot be reliably measured in this case as the layer does not completely cover the surface of the sulfur cathode) shows an improved stability but the stability is still poor. However, the cycling stability is increase from 67% to 90% after 500 cycles under 0.2 C at 25° C.(capacity retention) with the increase of the thickness of the BNNT layer from 0.9 μm to 2.3 μm, indicating the BNNT layer improves the cycling stability of the sulfur cathodes.

The single-layer Li—S pouch cells with the obtained BNNT interlayer coated sulfur cathodes were fabricated and tested. The cycling stability of the pouch cells was investigated in detail. The BNNT interlayers are made with the slurry where the weight ratio of the BNNT is 5% of the weight of the total slurry including BNNT, binder and solvent. The capacity of the pouch cell without BNNT interlayers drops to 65.2% after 50 cycles, while the pouch cells with 0.9 μm to 2.3 μm BNNT layer keep 82% and 95% of initial capacity, indicating the BNNT layer significantly improves the cycling stability of the sulfur cathodes.

### Demonstration of Polysulfide Blocking

A polysulfide (PS) solution (0.136 mol/L of Li₂S₈ in commercial electrolyte—1 M LiTFSI in DOL/DME with 1% LiNO₃) was made and transferred into 2 bottles. FIG. 4(a) shows the polysulfide solution without (yellow) and with BNNT (yellow colour is lost). The polysulfide solution is yellow in colour due to the PS present. However, with the addition of 5 mg BNNT, the yellow colour disappears instantaneously signifying association of PS with the BNNTs such that dissolved PS is drawn out of solution. IR analysis was conducted on a series of polysulfide solutions with differing amounts of BNNT added (0 mg, 8 mg and 15 mg BNNTs added). The IR results in FIG. 4(b) show the reduction in the intensity of the Li₂S₈ absorption peak after addition of BNNT into the polysulfide solution. This indicates that polysulfide is adsorbed by BNNT. Raman analysis was also carried out. The results in FIG. 4(c) shows B—S and N—S bonds in the BNNTs-polysulfide sample recovered from the BNNT treated PS solutions, further evidencing that BNNT adsorbs polysulfides. The absorption of PS from solution onto BNNT shows that the BNNT traps the PS. In an energy storage/battery environment, the S adsorption onto the BNNT film/deposit prevents PS lost into the electrolyte and thus prevents loss of cathode mass which otherwise would occur on cycling. When the optimised thickness and density of the BNNT composite film is used, the PS is reversibly trapped by the BNNTs such that the PS/S remains electrochemically active.

Indeed, FIG. 7 illustrates (a) the specific capacity and (b) capacity retention of a test S-cathode with a variety of BNNTs loading densities for 100 cycles. The BNNTs loading density are 0.05, 0.1, 0.2, 0.25 and 0.5 mg/cm², respectively. All tested cells in (a) performed an acceptable initial specific capacity at the range of 1150 to 1250 mAh/g. These cells show a 69.4, 73.7, 85.7, 77.8 and 75.2% capacity retention at the 100^{th} cycle (relative to capacity of 1^{st} cycle). A BNNTs loading density of about 0.1 to about 0.25 mg/cm² gives a particularly good performance in terms of the capacity retention c.f. the 1^{st} cycle.

### Embodiment 2—a Coating of a BNNT Mesh Controls Dendrite Formation on a Metal Electrode

During electrochemical metal plating and stripping or during energy device charge and discharge cycling (involving electrochemical metal plating and stripping), a metal anode material continuously experiences heterogenous volume expansion and contraction concentrated in different areas across the anode to a degree that cracks, fracturing or otherwise damages a native SEI during battery operation. When cracks or fractures form in a native SEI, large uncontrolled metal ion influx arriving that particular area of the anode is easily transported through to the metal surface which leads to the formation of metal nucleation sites on the electrode surface from which dendrites grow. Thus, SEI instability has been a limiting factor in advancement of energy storage devices involving metal anodes. Described herein is a metal electrode for an energy storage device having a composite of boron nitride nanotubes (BNNTs) and at least one polymeric binder, wherein a coating of the composite intimately contacts at least one surface of the electrode as a porous mesh which is selectively permeable to transport metal ions used in the energy storage device, wherein the composite is physically and/or chemically bonded to the surface of the electrode. The mesh is configured to homogeneously distributes metal transport ions traversing the mesh across an entire surface of the metal electrode thereby reducing metal dendrite formation.

The BNNT porous mesh of the invention has been found to solve the problem of dendrite formation on a metal electrode during electrochemical metal plating and stripping or during energy device charge and discharge cycling which involves electrochemical metal plating and stripping. It is believed that the BNNT porous mesh of the invention comprises one or more of tunnels, pathways and/or channels therethrough, which are directed, orientated and/or dimensioned to redistribute a concentrated metal ion flux found on one side of the mesh to a more uniformly distributed metal ion flux on the other side of the mesh, whereby the metal ion flux is thereby distributed across a greater surface area of the anode. The tunnels, pathways and/or channels therethrough are configured or directed laterally towards the sides of the electrode, that is, away from any one location or area of the electrode. The direction of tunnels, pathways and/or channels therethrough take a concentrated metal ion flux and redistributes it across the body of the electrode. In short, transport through the mesh results in division of the concentrated metal ion flux into a plurality of smaller ion fluxes which are spread out uniformly across the surface of the anode resulting in homogenous metal plating on the anode surface. Without the coating of the BNNT porous mesh the concentrated metal ion flux would all target a very localised area of the anode surface, leading to significant and uncontrolled volume expansion. To distribute transport metal ions through the mesh right across the metal electrode surface, it is believed that the BNNT porous mesh segments the metal surface into more accessible regions. While this effect is achievable with a variety of mesh thickness, it is preferred that the thickness is optimised to ensure fast metal ion transport through the mesh to ensure good capacity retention and also to keep the internal resistance of a device comprising the protected anode as low as possible. In a preferred embodiment, the coating of composite of BNNT porous mesh has an average thickness of from about 1 microns to about 50 microns, more preferably from about 2 microns to about 25 microns, more preferably about 3 to 10 microns, preferably around 1.5 microns or around 7.5 microns, most preferably about 5 microns. In a preferred embodiment, the coating of the composite has an areal density or BNNT loading of from about 0.2 mg cm⁻² to about 8 mg cm⁻², about 0.1 mg cm⁻² to about 2 mg cm⁻², more preferably from about 0.1 to about 2 mg cm⁻², most preferably about 0.4 mg cm⁻².

In preferred a preferred coating of composite porous mesh, at least a portion of the polymer binder is present as particulates which fix strands of the BNNTs together to form the porous network or porous mesh. Further, at least a portion of the polymer binder is present as particulates which fix strands of BNNTs together to form the porous mesh. Desirably, strands of BNNTs are not completely conformally coated with the polymeric binder. Suitably, the BNNTs are substantially free, preferably completely free, of impurities hexagonal boron nitride and/or elemental boron. Preferably, the metal is selected from Li, Na, K, Al, and Zn, preferably Li or Na. Desirably, the coating of the composite comprises the polymeric binder at a concentration of about 50 wt % or less, preferably 20 wt % or less, preferably 15 wt % or less, preferably about 10 wt % or less. Suitably, the BNNT porous mesh comprises one or more of tunnels, pathways and/or channels therethrough, directed, orientated and/or dimensioned to delocalised or redistribute a concentrated metal ion flux on one side of the mesh to a more uniformly distributed metal ion flux on the other side of the porous network/mesh, whereby the metal ion flux is thereby distributed across a greater surface area of the electrode.

Desirably, the BNNT porous mesh for a metal electrode comprises at least one binder, preferably a polymeric binder. Polymer binders are preferred due their flexible and/or elastic mechanical properties. Suitably the polymeric binder may be selected from any binder described herein but preferably are selected from a natural or a synthetic rubber, for example, a styrene butadiene rubber, poly(vinylidene fluoride-co-hexafluoropropene (PVDF-HFP), poly(3,4-ethylenedioxythiophene)-co-poly(ethyleneglycol) (PEDOT-co-PEG), polyethylene glycol (PEG)-polymethyl methacrylate (PMMA), poly (dimethylsiloxane) (PDMS) and combinations thereof. Desirably, the flexible polymer binder is poly(styrene-co-butadiene) or comprises poly(styrene-co-butadiene). Preferably, the flexible polymeric binder is poly(styrene-co-butadiene).

Thus, the present invention provides a BNNT porous mesh for a negative electrode (anode) for an energy storage device, preferably a rechargeable energy storage device. The invention concerns a protective coating for a metallic based anode material, the negative electrode having associated therewith boron nitride nanotubes (BNNTs) in the form of one or more deposits or interlayers of BNNTs having a porous mesh structure (hereinafter described as “BNNT porous mesh”). Preferred BNNT porous mesh of the invention is a flexible and/or elastic porous mesh. The flexible BNNT porous mesh of the invention strengthens, supports, scaffolds, and/or reinforces a native solid electrolyte interface (SEI) layer to resist cracking and fracturing and thus reduces opportunity or tendency for site nucleation and subsequent dendrite formation/growth to occur when a concentrated metal ion influx passes through crack in a native solid electrolyte interface (SEI). As used herein, “flexible” and/or “elastic” means the mesh resists cracking or breaking during electrochemical metal plating and stripping, for example, which occurs during charge-discharge cycling in an energy storage device at a current density range of from 0.1 mA cm⁻² to 20 mA cm⁻².

Further, the BNNT porous mesh of the invention has been found to have favourable physical and chemical properties for use as one or more of: an artificial SEI, a pseudo SEI and/or a support, a scaffold or reinforcement structure for a native SEI, strengthening it to prevent cracking, fracturing or damage during electrochemical metal plating and stripping. In preferred embodiments, the BNNT porous mesh mechanically supplements an existing native SEI. Preferred BNNT porous meshes of the invention are electronically insulating (that is act as a passivating layer) whilst being ionically conducting, that is, permeable to ions of the metallic based anode material but impermeable to electrons and non-transport metal ion components in the energy storage device. A preferred BNNT porous mesh is flexible enough to avoid cracking, fracture or other damage during cycling and is also of sufficient mechanical strength to control or at least mitigate the damaging effects of metal anode material volume expansion on native SEI which is experienced on metal plating and stripping, for example, electrochemical metal plating and stripping or during energy device cycling.

Furthermore, the mechanical properties of the BNNT porous mesh are believed to be such that the BNNT porous mesh may control or more uniformly direct metallic based anode material volume expansion across the anode surface area compared to an equivalent metallic based anode material without BNNT porous mesh. More uniform or homogenous control of volume expansion in this manner is thought to reduce the degree of stress and/or strain experienced by a native SEI, bolstering it against cracking, fracture or other damage typically experienced during electrochemical metal stripping/platting or cycling operations when in an energy storage device.

Preferably, the BNNT porous mesh comprises at least one distinct layer of BNNT which directly contacts electrolyte facing surfaces of the metal-based anode material.

Desirably, the BNNT porous mesh is in the form of a standalone or free-standing film positioned over or proximate to electrolyte facing surfaces of the metallic based anode material.

Suitably, the BNNT porous mesh is in the form of a coating directly on electrolyte facing surfaces of the metallic based anode material. The SEI when formed on cycling sits between the BNNT porous mesh and the metal anode surface. In some embodiments, the BNNT network/mesh is physical bound and/or chemically bound to one or more of the electrode material and/or the SEI when it forms, for example, via physical entanglements or covalent and/ionic bonds between atoms in the network/mesh and the SEI components. In any case, interfacial contact/intimate contact between the BNNT layer and the electrode/SEI is desirable.

Desirably, the BNNT porous mesh is in the form of a three-dimensional (3D) porous film, porous network/mesh or a porous deposit of boron nitride nanotubes (BNNTs) mesh. Desirably, the BNNT porous mesh is homogenous across its area in one or more of composition, morphology, ionic conductivity, and modulus.

Suitably, the BNNT porous mesh may comprise intersecting and/or intercrossing filaments which form a network or grid of connected, contacting or intersecting filaments or strands of BNNT, particularly entangled, intersecting, interlaced or intertwined BNNT. Desirably, the BNNT porous mesh is a disordered mesh of filaments or strands of BNNTs. The BNNT porous mesh is believed to comprise one or more of tunnels, pathways and/or channels through and across the mesh, which are spatially positioned, orientated, directed and/or dimensioned to more uniformly and/or more homogenously redirect, spread, and/or redistribute a concentrated metal ion flux of metal ions (reaching a particular area of the mesh on the electrolyte side) through the mesh to be more uniformly distributed or delivered across the breadth of the surface of the anode after passing through the BNNT porous mesh. The tunnels, pathways and/or channels therethrough, directed, orientated and/or dimensioned to delocalised or redistribute a concentrated metal ion flux found on one side of the mesh to a more uniformly distributed metal ion flux on the other side of the mesh, whereby the metal ion flux is thereby distributed across a greater surface area of the anode. This metal ion influx redistribution, spreading and/or redirection advantageously allows a metal ion influx to be divided, to be more uniformly and orderly distributed across a much larger surface area of the metal anode than would be possible for an anode without the BNNT porous mesh where a concentrated ion influx tends to be more localised. In short, by passing through the mesh, a concentrated ion flux is delocalised across the breadth of the metal anode surface. Since metal ions reaching the metal anode surface are delocalised and more uniformly and more homogenously spread out across the anode surface, volume expansion is better controlled and is more consistent/more homogenous across the entire anode, thereby minimising stress and strain experienced by various different parts/portions or areas of the SEI which forms at the anode-electrolyte interface on electrochemical metal plating/stripping or charge/discharge cycling in an energy storage device. Since the native SEI experiences less overall stress as a result of the ion redistribution caused by the BNNT porous mesh, there is a much reduced tendency towards cracking and fracturing of the SEI. This reduces the opportunity for metal dendrite site nucleation and subsequent growth. In short, the BNNT porous mesh hinders dendrite formation through induction of ion delocalisation and more uniform distribution of the metal ions passing through the mesh to reach a much greater breadth of the anode surface compared to what occurs without the BNNT porous mesh. These benefits are clearly observable through stable and prolonged electrochemical metal plating and stripping in a symmetrical cell arrangement or stable cycling in an energy storage device. The fact that cycling stability is observed infers that dendrite formation is not occurring to a degree that causes the cell to short circuit after only a few cycles which occurs in the absence of the BNNT network/mesh on the metal electrode.

It is believed that as a result of the BNNT porous mesh, a large metal ion flux reaching the mesh is divided into a plurality of smaller but more uniformly directed streams of ion flux which traverse the mesh in a way that leads to a more uniform or more homogeneous deposition of the metal across the breadth of the anode surface. Essentially, the mesh facilitates for the first time more delocalised ion directioning, and thus more uniform, homogenous and controlled electrochemical metal plating, as well as more homogeneous and controlled volume expansion across the anode thereby exposing a native SEI to less damaging stress and strain.

A schematic of this ion screening/filtering or control mechanism is shown in FIG. 14 in the case of a Li metal anode coated with BNNT porous mesh. Thus, preferably, the pores, tunnels, pathways and/or channels associated with the BNNT porous mesh are dimensioned, directed, directioned and/or orientated to manipulate, control and/or redirect a flux of metal ions attracted to the metallic based anode material by dividing them into more ordered, spatially spread out component ion flows through the mesh which has the effect of spreading out ions flows across the surface of the anode material on passing through the mesh

Suitably, the BNNT porous mesh is electronically insulating but permeable to metal transport

Preferably, the BNNT porous network/mesh is homogenous in one or more of composition, morphology, thickness ionic conductivity, and mechanical properties. In particularly, the composition and thickness and mechanical properties can be controlled or tailored for any given application by varying one or more of the relative concentrations of BNNT and polymer binder in the mesh slurry as well as the slurry coating thickness, the BNNT lengths and diameters etc. The same applies to the BNNT porous network/mesh for the S cathode embodiment.

Suitably, the BNNT porous mesh is flexible and/or elastic such that it resists cracking or breaking during electrochemical plating and stripping. Desirably, the BNNT porous mesh is flexible and/or elastic under electrochemical metal ion plating and stripping conditions. This is demonstrated by little or no cracking or breaking, for example, after at least 100 charge/discharge cycles at a charge density of 1 mA cm⁻² at a fixed charge/discharge capacity of 1 mAh cm⁻². Under these conditions, a cycle takes 2 hours, that is a metal plating time of 1 hour and a metal stripping time of 1 hour. It will be understood that metal ion plating and stripping studies may be carried out in a symmetrical cell comprising metal electrodes. For example, a preferred BNNT porous mesh is flexible under lithium-ion plating and stripping conditions as demonstrated by little or no cracking or breaking, for example, after at least 600 charge/discharge cycles at a charge density of 1 mA cm⁻² at a fixed charge/discharge capacity of 1 mAh cm⁻². Preferably, the metallic based anode material comprising an alkali metal, for example, Li, Na, K, preferably Li or Na, most preferably Li. Suitably, the metallic based anode material comprises lithium metal.

Preferably, the BNNT porous mesh is physically and/or chemically stable in the presence of the metallic based anode material. Preferably, the BNNT porous mesh is physically and/or chemically stable in the presence of an electrolyte or electrolyte systems typically used in energy storage devices/applications.

Preferably, the boron nitride nanotubes of the BNNT porous described herein for any electrode are of a length of at least about 0.5 microns, more preferably at least 1 micron. In one preferred embodiment, BNNTs have a length of from about 1 to about 50 microns. In one example, BNNTs of a length of about 10 microns are particularly preferred. Preferably, the boron nitride nanotubes have a diameter of about 500 nm or less. Preferred diameters range from about 50 nm to about 100 nm, more preferably about 100 nm.

Desirably, the boron nitride nanotubes are present in the BNNT porous mesh in an amount ranging from about 20% to about 95% by weight of the boron nitride nanotubes (BNNTs) film or deposit, preferably about 50% to about 90% by weight, most preferably about 85% by weight to about 98% by weight. In some embodiments, 90% by weight BNNT are preferred.

Suitably, the binder is present in the BNNT porous mesh in an amount ranging from about 5% to about 80 wt %, more preferably from 10% to 50% by weight of the BNNT porous mesh, preferably about 10 wt % by weight of the BNNT porous mesh. It will be understood that higher amounts of binder, particularly flexible binder, provide a mesh which a greater degree of flexibility. Preferably, the boron nitride nanotubes of the BNNT porous mesh have a density of from about 0.2 mg cm⁻² to about 8 mg cm⁻², more preferably about 0.2 mg cm⁻² to about 1.7 mg cm⁻², more preferably from about 0.5 to about 0.75 mg cm⁻².

Preferably, the coating of the boron nitride nanotubes (BNNTs) mesh has an average thickness of from about 0.1 microns to about 100 microns, preferably from about 1 micron to about 50 microns, more preferably about 2 microns to about 25 microns, more preferably about 3 microns to about 10 microns, most preferably about 1 to 10 microns. In some embodiments, the boron nitride nanotube (BNNTs) deposit has an average thickness of from about 0.9 microns to about 4.4 microns, preferably about 1.9 microns or about 2.3 microns. In other embodiments the thickness is preferably around 1.5 microns to around 7.5 microns, most preferably about 5 microns.

Preferably, the metal or metal-based anode material is deposited on a current collector, preferably a copper foil, an aluminium foil, a carbon cloth, carbon fibre or composite, copper foam, nickel foam. In some embodiments, a current collector is not included for example where the metal anode is an Al metal anode or a Zn metal anode, a current collector is not required.

The invention also relates to an energy storage device comprising one or more negative electrodes (anodes) of the invention.

The invention extends to an energy storage device comprising one or more metal or metal based electrodes according the present invention, preferably a lithium or sodium metal anode. Desirably, the energy storage device further comprises: at least one cathode, at least one separator; and an electrolyte. Desirably, the cathode is a sulfur based or a sulfur-graphene cathode, an oxygen cathode, a lithium iron phosphate cathode or a lithium nickel manganese oxide cathode.

A preferred device exhibits stable electrochemical metal plating and stripping for at least 100, at least 500, at least 1000, charge/discharge cycles at a charge density of 1 mA cm⁻² and a charge/discharge capacity fixed to 1 mAh cm⁻² at a temperature of 25° C. Preferably, wherein the sulfur or sulfur-graphene cathode is provided with a coating of a composite of boron nitride nanotubes (BNNTs) and at least one polymeric binder in the form of porous mesh which is selectively permeable to transport metal ions used in the energy storage device.

In a preferred embodiment, the invention extends to a metal-sulfur energy storage device comprising
at least one metal electrode having a coating of a composite of boron nitride nanotubes (BNNTs) and at least one polymeric binder, wherein the coating of the composite intimately contacts at least one surface of the electrode as a porous mesh which is selectively permeable to transport metal ions used in the energy storage device wherein the composite is physically and/or chemically bonded to the surface of the electrode; and
at least one sulfur (S) based electrode having a film of a composite of boron nitride nanotubes (BNNTs) and at least one polymeric binder, wherein the film of the composite intimately contacts at least one surface of the electrode as a porous network which is selectively permeable to transport metal ions and electrolyte used in the energy storage device but is impermeable to polysulfides.

In another preferred embodiment, the invention extends to a lithium-sulfur energy storage device comprising
at least one lithium metal electrode having a coating of a composite of boron nitride nanotubes (BNNTs) and at least one polymeric binder, wherein the coating of the composite intimately contacts at least one surface of the electrode as a porous mesh which is selectively permeable to lithium ions used in the energy storage device, wherein the composite is physically and/or chemically bonded to the surface of the electrode; and
at least one sulfur (S) based electrode having a film of a composite of boron nitride nanotubes (BNNTs) and at least one polymeric binder, wherein film of the composite intimately contacts at least one surface of the electrode as a porous network which is selectively permeable to metalithium ions and electrolyte used in the energy storage device but is impermeable to polysulfides.

Preferably the BNNT loading in the cathode network is about 0.2 mg cm⁻². Preferably the BNNT loading in the anode mesh is about 0.4 mg cm⁻². About means±5%.

For any energy storage device embodiment described herein, it will be understood that a unit cell comprises one anode and one cathode. Furthermore, an energy storage device in the form of a pack of a module will comprise more than one of each of anode and cathode, but nevertheless will have a 1:1 overall ratio of anode to cathode.

A preferred energy storage device comprises a metallic based anode material, the negative electrode having associated therewith boron nitride nanotubes (BNNTs) in the form of one or more deposits or interlayers of BNNT having a porous mesh structure. The BNNT porous mesh is as described above in more detail.

Desirably, the energy storage device comprises at least one negative electrode (anode) comprising a metallic based anode material, the negative electrode having associated therewith boron nitride nanotubes (BNNTs) in the form of one or more deposits or interlayers of BNNTs having a porous mesh structure; a separator between each anode and cathode; and at least one cathode; and electrolyte. Suitably separators and electrolytes are well known in the art.

Desirably, the energy storage device comprises at least one positive electrode (cathode) which is a sulfur based or a sulfur-graphene cathode, a catalyst cathode for Li—O₂ energy storage device, a lithium iron phosphate cathode or a lithium nickel manganese oxide cathode.

Desirably, the sulfur or sulfur based cathode of the energy storage device comprises a sulfur-cathode material having associated therewith a porous film or a porous deposit of boron nitride nanotubes (BNNTs). Such sulfur-cathode materials with BNNT interlayers are described in detail in Australian Provisional Application No. 2021900777, the content of which are hereby incorporated by reference.

Suitably, the energy storage device comprises an electrolyte or an electrolyte system that is compatible with the metallic based anode material, for example, in terms of one or more f safety, stability and energy device performance. For example, ether-based solvents such as DOL or DME or mixtures of DOL/DME can be used. These electrolytes may comprise ionic liquids and/or metal salts as required, preferably a salt such as LiNO₃ and/or an ionic liquid such as LiTFSI for a lithium device. Equivalent or similar sodium analogues may be used for a sodium device. One exemplified electrolyte used herein is 1 M LiTFSI in DOL/DME with 1 wt % LiNO₃. Such electrolytes may also be used in the S cathode embodiments described herein and in the polysulfide absorption experiment describe herein.

Suitably, a preferred composite BNNT porous mesh prevents dendrite formation and growth on the anode material during electrochemical metal stripping and plating, for example, as occurs in energy storage device operations during charge and discharge cycling. Desirably, the composite BNNT porous mesh of the invention can prevent dendrite formation and growth on the anode material during electrochemical metal stripping and plating for at least 60 cycles, more preferably at least 120 cycles, more preferably still at least 180 cycles, most preferably still at least 400 cycles, most preferably 1000 cycles or greater, for example, under metal plating and stripping conditions at a current density of 1 mA cm⁻² and a charge/discharge capacity fixed to 1 mAh cm⁻², e.g., using a 1 hour plate time and a 1 hour strip time. It will be understood that such metal ion plating and stripping stability performance studies may be carried out in a symmetrical metal cell. For example, a symmetrical Li-BNNT porous mesh anode|Li-BNNT porous mesh anode cell can be used for cycling stability performance testing of a Li metal-BNNT porous mesh electrode. In a preferred such cell the overpotential is maintained at 0.5 V or less for at least 100 cycles, more preferably at least 600 cycles, most preferably still at least 1500 cycles. Preferred systems maintain a stable overpotential of 0.2 V or less for at least 100 cycles, more preferably at least 600 cycles, most preferably still at least 1000 cycles. An overpotential of less than 0.5 V during electrochemical metal plating and stripping on such cycling is indicative of a lack of dendrite formation on a metal anode. Thus, a preferred BNNT porous mesh is stable for at least 100 cycles, at least 500 and even at least 1000 cycles of electrochemical metal plating and stripping as electrochemically demonstrated by lack of dendrite formation through a stable cycling overvoltage of 0.5 V or less, preferably at room temperature.

The invention also relates to a slurry for preparing a BNNT porous mesh for a metallic based anode material comprising boron nitride nanotubes (BNNTs), one or more polymeric binders, and one or more aprotic liquid organic solvents. Suitable binders and BNNTs have been described above.

Suitably, the ratio between the volume of slurry solvent and the weight of solid components has a range from 3 mL/g to 20 mL/g, preferably from about 5 mL/g to about 10 mL/g, most preferably about 7 mL/g. Suitably, the aprotic solvent is selected from ether solvents, ether based mixed solvent systems, carbonates, N,N-dimethylacetamide (DMAc), and combinations thereof. Suitably, the ether solvent or ether based mixed solvent system comprise linear ethers or cyclic ethers. Desirably, the ether solvent or ether based mixed solvent system is selected from diethyl ether, a dioxolane (DOL), a tetrahydrofuran (THF), a dimethyloxyethane (DME) and combinations thereof. Preferably, the carbonates solvent is selected from diethyl carbonate, dimethyl carbonate and combinations thereof.

The invention also relates to a method of preparing a negative electrode (anode) comprising a metallic based anode material having associated therewith boron nitride nanotubes (BNNTs) in the form of one or more deposits or interlayers of BNNTs having a porous mesh structure, the method comprising the steps of:
(i) preparing a slurry of BNNTs and binder in one or more aprotic solvents;
(ii) coating surfaces of a metallic based anode material with the slurry in a desired thickness;
(iii) evaporating the solvent to form a metallic based anode material having a deposit of BNNTs having a porous mesh structure. Suitably slurries have been described above, as have suitable binders, BNNTs and solvents. Suitably, the BNNTs are present in the slurry at a concentration of from about 20% to about 99 wt % of the slurry, preferably about 50% to about 95 wt %, more preferably from about 85 wt % to about 95 wt %, most preferably about 90 wt %. Preferably, polymeric binder is present in the slurry at a concentration of from about 1 wt % to about 80 wt % of the slurry, preferably about 5 wt % to about 50 wt %, more preferably from about 5 wt % to about 15 wt %, most preferably about 10 wt %. Preferably, a coating of the slurry has an initial thickness after coating of from about 50 microns to about 1000 microns, more preferably from about 100 microns to about 500 microns, most preferably about 200 microns.

Preferably, after solvent evaporation, a dried BNNT porous mesh layer is formed having a thickness of from about 1 micron to about 50 microns, more preferably from about 3 microns to about 40 microns, most preferably from about 7 microns to about 40 microns, most preferably from about 8 microns, 11 microns, 25 microns, or 37 microns. In one preferred example, the layer of dried BNNT porous mesh is about 11 microns thick.

A preferred method further comprising the step of providing the metallic based anode material on a negative electrode current collector, such as copper metal, preferably copper foil or aluminium foil. Other suitable current collectors are described above.

Preferably, the metal or metal based electrode comprises a transport ion metal, for example, Li, Na, K, Al, and Zn, preferably Li or Na. Suitably, the metallic based anode material is lithium or sodium, preferably lithium.

The invention also relates to a slurry for preparing a BNNT porous mesh for a metallic based anode material comprising boron nitride nanotubes (BNNTs), one or more polymeric binders, and one or more aprotic solvents. Desirably, the aprotic solvent is selected from ether solvents, ether based mixed solvent systems, carbonates, N,N-dimethylacetamide (DMAc), and combinations thereof. Preferably, the ether solvent or ether based mixed solvent system comprise linear ethers or cyclic ethers. Suitably, the ether solvent or ether based mixed solvent system is selected from diethyl ether, a dioxolane (DOL), a tetrahydrofuran (THF), a dimethyloxyethane (DME) and combinations thereof. Desirably, the carbonates solvent is selected from diethyl carbonate, dimethyl carbonate and combinations thereof.

The invention also relates to an electronic device comprising a negative electrode (anode) of the invention and/or the energy storage device of the invention. The invention also relates to use of an electronic device of the invention, in transportation, grid storage, electric vehicles, and advanced portable electronics applications.

The invention also relates to use of one or more layers of a composite BNNT porous mesh to prevent dendrite formation on a metallic based electrode of an energy storage device. Suitably, the metallic based electrode includes Na, K, Al or Zn metal anodes.

The invention also relates to use of one or more layers of a composite BNNT porous mesh to control volume expansion a metallic based electrode of an energy storage device.

The term “about” here means the number is to be taken as a range defined by ±0.1%, ±1%, ±5% or ±10% variation of the stated value depending on the standard error associated with the measurement method which will be understood by the person skilled in the art. In many cases, SEM analysis may be used to measure/estimate nano and micron measurements.

### Embodiment 2—Materials and Methods

Fabrication of Li-BNNT anodes: The lithium film is supplied from China Energy Lithium Co., Ltd., where 100 μm-thick lithium film is coated on both sides of a copper current collector. The lithium anodes were further coated with a BNNT interlayer. The BNNT interlayer was prepared by mixing 90 wt % BNNT, 10 wt % Styrene Butadiene Rubber (SBR, poly(styrene-co-butadiene) from Sigma Aldrich) in tetrahydrofuran (THF, Sigma-Aldrich) solution (5 mL). The slurry was stirred overnight and coated onto the surface of the lithium anode in an argon-filled glovebox with sub-ppm oxygen and water level and baked overnight at 60° C.

Fabrication of symmetric lithium pouch cells: Symmetric lithium pouch cells were fabricated in an argon filled glovebox. Two pieces of Li-BNNT electrodes are cut and then paired with a separator (Celgard 2400) in a commercial soft Al plastic film. 1 mL electrolyte was dropped into the pouch and the electrolyte is 1 M LiTFSI in DOL/DME with 1 wt % LiNO₃. The pouch cell was sealed with a vacuum sealer in the glovebox.

Electrochemical Measurements. All the coin cells and soft packaged cells were assembled in an Ar-filled glovebox with O₂ and H₂O<1 ppm. The AC impedance of symmetric Li/Li cells (frequency range from 0.1 to 106 Hz at an amplitude of 10 mV) was examined using a Solartron 1255B frequency response analyzer. A Neware eight-channel battery tester was used to conduct the galvanostatic cycling test.

Embodiment 2—Results and discussion—To adjust the thickness of the BNNT-mesh, the BNNT-SBR slurry was coated on copper foils with different doctor blade gaps controlled to 100 μm, 200 μm, 300 μm and 400 μm, and are then dried to form a dry, final layer of BNNT porous mesh which comprises BNNTs in polymeric binder matrix. The cross-section SEM images of the BNNT-mesh on Cu foils made with different gaps were examined as having gaps of (a) 100 microns (b) 200 microns (c) 300 microns and (d) 400 microns. The thicknesses of the corresponding BNNT porous mesh layers after drying are ˜8 μm, 11 μm, 25 μm and 37 μm, corresponding to the doctor blade gaps of 100 μm, 200 μm, 300 μm and 400 μm, respectively. This results clearly indicate that the thickness of the BNNT porous mesh can be easily controlled by adjusting the blade gap during slurry coating. In a preferred example, the BNNT slurry is coated on a lithium film with a gap of 200 μm and dried to a thickness of 11 microns.

FIG. 8b demonstrates that a highly interconnected and porous mesh in nanoscale which is formed with BNNT and which can be clearly observed. This interconnected porous network of BNNT porous mesh is believed to lead to the uniform redistribution of ion flux of the metallic ions reaching the mesh on the electrolyte side through to the metal anode surface. Symmetric lithium pouch cells consisting of two lithium metal electrodes are fabricated to investigate the cycling performance of the lithium film with and without BNNT porous mesh. In the first cell, two fresh lithium films are used as the electrodes, while lithium films with BNNT porous meshes are used in the second cells. Both of the cells are tested under the same conditions which is 1 mA cm⁻² charge density and the charge/discharge capacity is fixed to 1 mAh cm⁻². Therefore, it takes 2 hours for 1 charge-discharge cycle. It can be found that the overpotential of the cell with fresh lithium film is about 0.1 V at the first 20 cycles in FIG. 12a. However, the voltage increased at 30 cycles and reach 3 V at the 64^{th} cycle, indicating the formation of lithium dendrites. In contrast, the cell with Li-BNNT porous mesh shows a highly stable cycling voltage profile for over 200 cycles after an activation process at the first cycles. In this second cell, the overpotential stays around 0.015 V for over 200 cycles, indicating there is no dendrite formation during cycling. This indicates that the BNNT porous mesh is controlling volume expansion and is mechanically aiding/strengthening the SEI to reduce cracking and damage that is necessary for dendrites to grow. In additional data available but not shown herein, a stable cycling voltage profile has now been observed for over 400 cycles. It is believed that the BNNT porous mesh significantly improves the cycling stability of the lithium metal electrode and prevents dendrite growth by protecting and reinforcing the SEI as well as lessening the stress and/or strain placed on native SEI by the mechanisms described above, but in particular, by homogenising volume expansion across the anode. Therefore preferred BNNT porous mesh limits strain and strain on native solid-electrolyte interface (SEI) from metallic based anode material volume expansion compared to an equivalent metallic based anode material without BNNT porous mesh.

It is believed that this is due to one or more of: 1) the electronically insulating, but porous and interconnected BNNT network acts as a screen/mesh to divide/delocalise a large fluxion of lithium ions arriving to the mesh on the electrolyte side into a smaller more uniformly distributed ion flow on passing through the mesh, leading to a more uniform more homogenously distribution of deposit of lithium across the anode surface, overall which leads to reduced opportunity for dendrite growth/site nucleation; 2) the excellent mechanical properties of the flexible polymer binder with the BNNT makes a mechanically strong SEI for the lithium electrodes, which accommodate the volume change of the lithium during cycling without causing cracks or damage to the SEI. Thus, the BNNT porous mesh is electronically insulating but permeable to ions of the metallic based anode material.

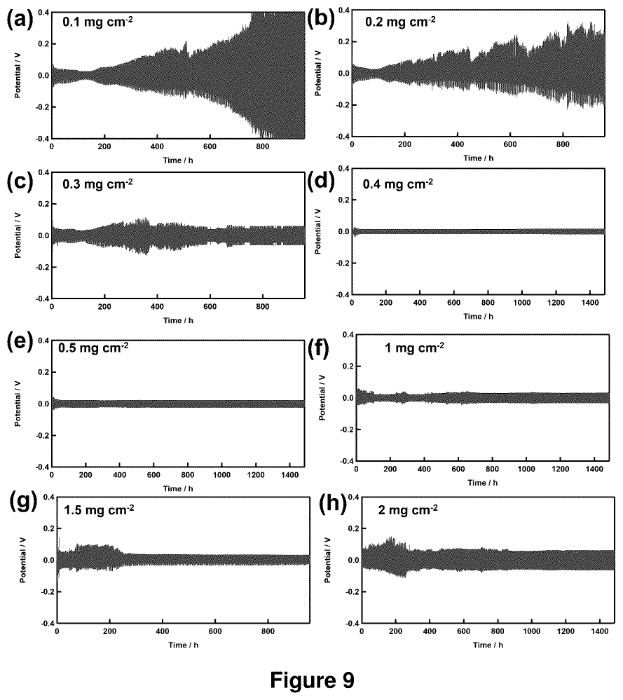

FIG. 9 illustrates the voltage profiles of Li ion plating and stripping cycling performance of the tested symmetric Li coin cells. The cells are tested under a current density of 1 mA/cm² with a capacity of 1 mAh/cm². The lithium foils used in the symmetric cells are coated with different mass loading of BNNT as follows: (a) 0.1 mg/cm², (b) 0.2 mg/cm², (c) 0.3 mg/cm², (d) 0.4 mg/cm², (e) 0.5 mg/cm², (f) 1 mg/cm², (g) 1.5 mg/cm², and (h) 2 mg/cm². The plots show that the plating/stripping overpotential of the Li symmetric cells with BNNT loading of 0.1 and 0.2 mg/cm² increased after 200 h. While the cells with the BNNT loading from 0.3 to 2 mg/cm² performed much better in terms of stability and exhibit a longer cycling life of 1400 h. A BNNTs loading density of about 0.4 mg/cm² gives a particularly low overpotential in terms of 32 mV. It is also evident that when the BNNT loading continues to increase to over 1 mg/cm², the overpotential of the cells increase.

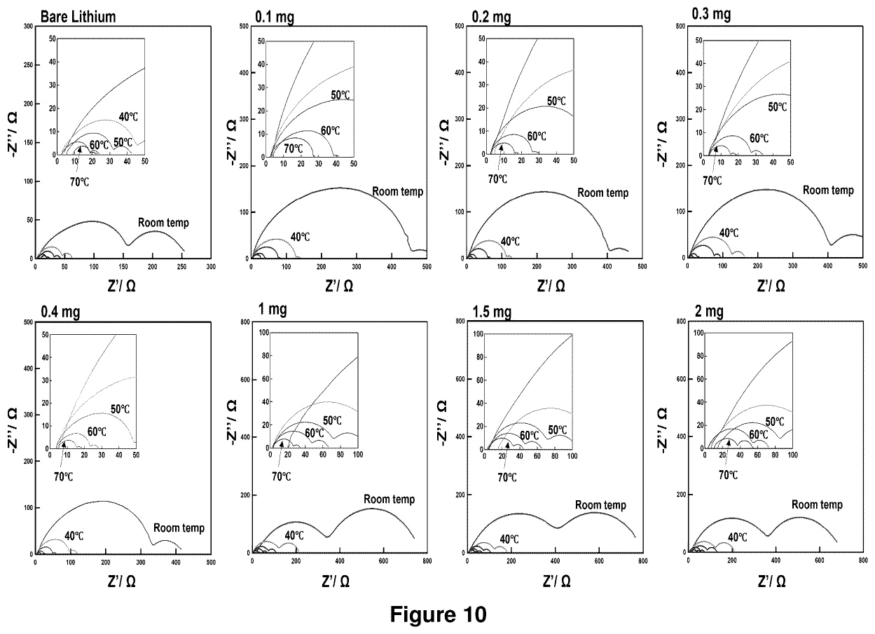

FIG. 10 illustrates an EIS analysis of the Li symmetric coin cells with different BNNT mass loading on the Li chips as follows: (a) Bare Li, (b) 0.1 mg/cm², (c) 0.2 mg/cm², (d) 0.3 mg/cm², (e) 0.4 mg/cm², (f) 1 mg/cm², (g) 1.5 mg/cm², and (h) 2 mg/cm². All the coin cells were tested at room temperature, 40, 50, 60 and 70° C., respectively to confirm transfer speed of Li ion for the series of different BNNT loading densities. The testing frequency range is from 1000 kHz to 0.1 Hz. The semi cycles at each temperature indicated the ionic resistance at the corresponding temperature. The Li ion with higher transfer speed higher reduction in resistance as the temperature increases. The EIS plots were fitting with a fitting software (Zview) and calculated to ionic conductivity.

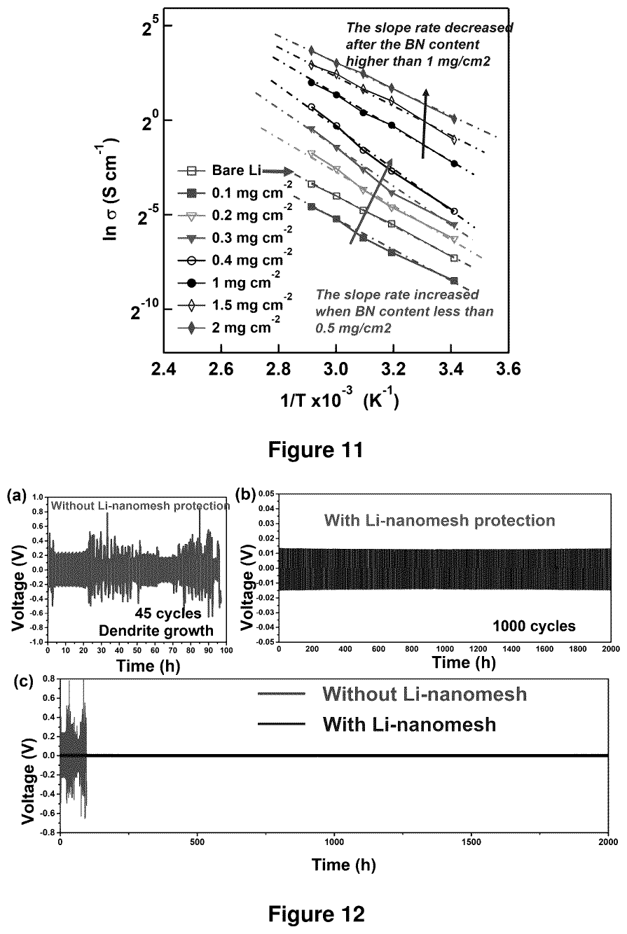

FIG. 11 illustrates the Arrhenius plot made according to the Nyquist plots of the Li symmetric coin cells with different BNNT mass loading on the Li chips. The BNNT loading range is 0.1 to 2 mg/cm². The Li ion with higher transfer speed exhibited a higher increase in ionic conductivity as the temperature increases, while the logarithm of ionic conductivity is linear related with the reciprocal of temperature. Therefore, the higher slopes of these plotted lines indicated a higher Li ion transfer speed. When the BNNT loading was less than 0.5 mg/cm², the slope increases with increasing BNNT loading. The slope decreased after the BNNT loading was higher than 1 mg/cm². A BNNTs loading density of about 0.4 mg/cm² gives a particularly high Li ion transfer speed which is corresponding to the results of symmetric Li coin cells.

FIG. 12 illustrates long-term plating/stripping cycling performance of a symmetric pouch cell with fresh lithium film electrode (a) without and (b) with BNNT porous mesh (the BNNT mass loading in the mesh is 0.4 mg/cm²). Their performances are compared in one graph FIG. 12(c). Without the BNNT porous mesh, the overpotential increases with cycling as dendrite formation occurs on lithium metal with cell failure occurring after 45 cycles, whereas the cell with the coating of BNNT porous mesh on the lithium metal cycles with a steady overpotential for at least 1000 cycles demonstrating lack of dendrite growth as a result of the protective coating of the composite BNNT porous mesh on the Li electrodes;

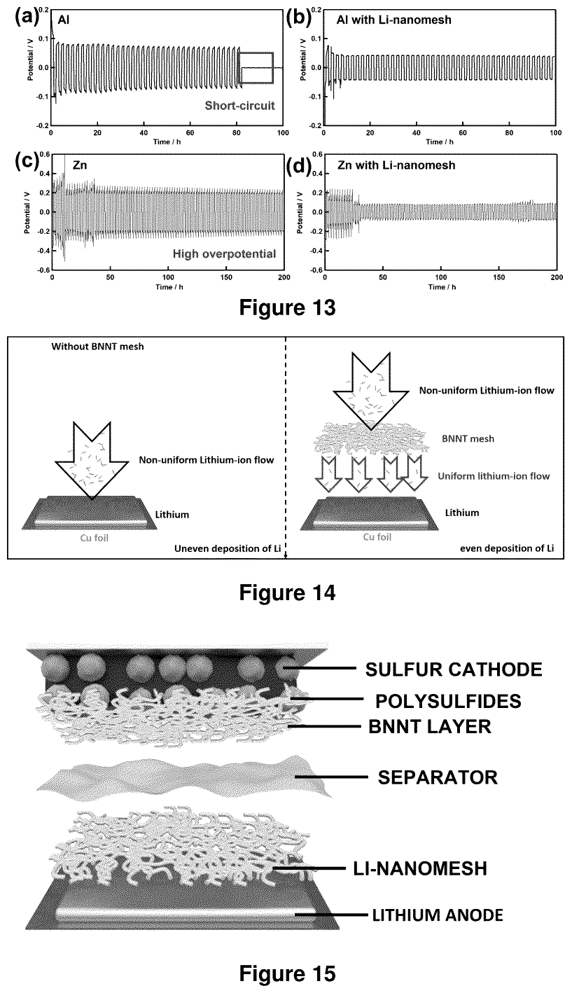

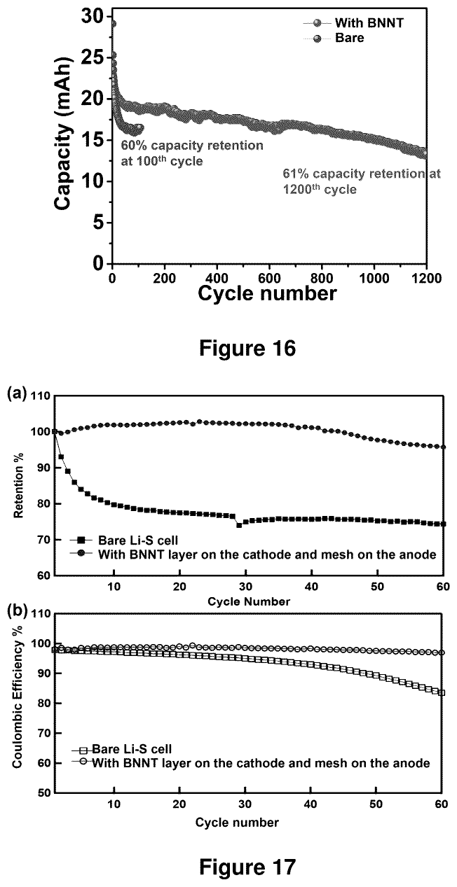

FIG. 13 illustrates the voltage profiles of plating and stripping cycling performance of symmetric Al metal batteries and symmetric Zn metal batteries with different metal electrodes (which also experience dendrite growth on platting/stripping/cycling) as follows: (a) Bare Al (b) Al with BNNT porous mesh (c) Bare Zn (d) Zn with BNNT porous mesh. The cells are tested under a current density of 1 mA/cm² with a capacity of 1 mAh/cm². The BNNT loading of the mesh is 0.4 mg/cm² in each case. The symmetric battery with bare Al failed after cycling for 80 h, while the symmetric batteries with the coating of composite BNNT porous mesh on the Al demonstrate a lower over potential than the cells with bare Al and a stable cycle of 100 h. Similarly, the Bare Zn symmetric battery performed a higher over potential (0.29 V) than that (0.09 V) of Zn with the coating of composite of BNNT porous mesh symmetric battery. These results clearly indicated that the coating of composite BNNT porous mesh can be applied to various metal anodes and prevent dendrite growth on the metal anodes as demonstrated by low and stable overpotential for many cycles.

In conclusion, the tailorable coating of a composite BNNT porous mesh comprising BNNT and a flexible polymer binder is designed and synthesized conveniently with a scalable method as described herein. The SEM images confirm that the BNNT porous mesh consists of porous and interconnected networks which are made of BNNT in a flexible/elastic polymeric matrix whereby the polymer is present in solid particulate form between the BNNTs strands. The electrochemical results prove that BNNT porous mesh significantly improve the cycling stability of each of a lithium, aluminium and zinc metal electrode, which is clear evidence that dendrite growth is prevented. Further, the inventors believe that the coating of BNNT porous mesh described herein for protective use with a metal anode is mechanically strong enough and flexible/elastic enough to protect the SEI from cracking, fracturing or other damage which typically occurs during volume expansion. Overall, the mechanical properties and porosity/morphology of the BNNT mesh suppresses dendrite growth during electrochemical metal plating and stripping (stable and low overpotential on prolonged cycling) and cell cycling (good stable capacity retention on prolonged cycling). The polymer binder in the mesh allows the mesh to retain structural integrity without itself cracking in the presence of volume expansion that occurs during cycling. Further the binder does not interfere with transport ion movement across the mesh. In short, the high ionic conductivity of transport metal ions through the coating of BNNT porous mesh described herein results in delocalised/more uniform ion transport across the entire electrode surface while better controlling volume expansion and thus reduced SEI cracking to prevent formation of dendrite nucleation sites.

1. A sulfur (S) based electrode for an energy storage device having a film of a composite of boron nitride nanotubes (BNNTs) and at least one polymeric binder, wherein the film of the composite intimately contacts at least one surface of the S electrode as a porous network which is selectively permeable to transport metal ions and electrolyte used in the energy storage device but impermeable to polysulfides.

2. The electrode of claim 1, wherein the BNNTs of the composite are substantially free of impurities such as hexagonal boron nitride (hBN) and/or elemental boron (B).

3. The electrode of claim 1, wherein at least a portion of the polymer binder is present in the composite as solid particulates which fix or adhere strands of BNNTs in the composite together to form the porous network.

4. The electrode of claim 1, wherein strands of BNNTs in the film of composite are not completely conformally coated with the polymeric binder.

5. The electrode of claim 1, wherein the film of composite has an average thickness of from about 0.9 microns to about 5 microns, preferably from about 1.5 microns to about 3.5 microns, most preferably about 2.5 microns.

6. The electrode of claim 1, wherein the film of composite has an areal density or BNNT loading of from about 0.05 mg cm⁻² to about 3.5 mg cm⁻².

7. The electrode of claim 1, wherein the S in the electrode is present at a loading of about 1 mg cm⁻² to about 8 mg cm⁻².

8. The electrode of claim 1, wherein the film of composite comprises the polymeric binder at a concentration of about 15 wt % or less of the composite weight.

9. The electrode of claim 1, wherein the film of composite is physically and/or chemically bonded to the surface of the electrode.

10. The electrode of claim 1, wherein the film of composite has tunnels, pathways, or channels therethrough dimensioned to allow selective passage of the transport metal ions through the porous network while reversibly trapping polysulfide in the porous network.

11. The electrode of claim 1, wherein the polymeric binder comprises PVDF, PEO, PTFE or LA133.

12. The electrode of claim 1, wherein the electrode comprises one more conductivity enhancing agents.

13. The electrode of claim 12, wherein conductivity enhancing agent is one or more graphenes present in an amount of from about 0.2 mg cm⁻² to about 0.6 mg cm⁻².

14. The electrode of claim 12, wherein the electrode is a sulfur-graphene based electrode material, wherein the graphene is a mixture of high porosity graphene and high surface area graphene.

15. The electrode of claim 14, wherein the electrode has a ratio of from 1:9 to 9:1 of high porosity graphene and high surface area graphene.

16-25. (canceled)

26. The electrode of claim 1, wherein the film of composite has an average thickness of from about 1.5 microns to about 3.5 microns.

27. The electrode of claim 1, wherein the film of composite has an average thickness of about 2.5 microns.

28. The electrode of claims 5, wherein the film of composite has an areal density or BNNT loading of from about 0.05 to about 0.5 mg cm⁻².

29. The electrode of claims 5, wherein the film of composite has an areal density or BNNT loading of from about 0.2 mg cm⁻².

30. A sulfur (S) based cathode electrode comprising a sulfur-cathode material having associated therewith a porous film or a porous deposit of boron nitride nanotubes (BNNTs),
wherein the film of composite has an average thickness of from about 0.9 microns to about 5 microns as determined by SEM, and
wherein the film of composite has an areal density or BNNT loading of from about 0.1 mg cm⁻² to about 3.5 mg cm⁻².
